(19) United States
(12) Patent Application Publication
(10) Pub. No.: US 2019/0311649 A1
(43) Pub. Date: Oct. 10, 2019

(54) Learning Management System for Task-Based Objectives

(71) Applicant: Snofolio Corp., Salt Lake City, UT (US)

(72) Inventor: Mark William COOK, Salt Lake City, UT (US)

(21) Appl. No.: 16/372,013

(22) Filed: Apr. 1, 2019

Related U.S. Application Data
(60) Provisional application No. 62/653,265, filed on Apr. 5, 2018.

(51) Int. Cl. G09B 19/00; G09B 5/00

(52) U.S. Cl. CPC G09B 19/0038; G09B 5/00

(57) ABSTRACT

Techniques for generating, monitoring, and assessing task-based learning objectives via a learning management system are disclosed. A set of trackable criteria is generated for an instructee, where the set is managed by a digital portfolio stored in a cloud environment. The digital portfolio is accessible by the instructee and an instructor. Performance data, which describes the instructee's performance of the criteria, is received. Then, assessment data is received, where the assessment data details an assessment of the performance data by describing how closely the instructee's performance data corresponds with a desired performance defined by the trackable criteria. The assessment data also includes an overall ranking of the performance. A report is generated and displayed on a user interface having a particular visual layout. The trackable criteria are then modified based on the assessment data.

### CROSS-REFERENCE TO RELATED APPLICATIONS

This application claims the benefit of and priority to U.S. Provisional Patent Application Ser. No. 62/653,265 filed on Apr. 5, 2018 and entitled “SKI TRAINING MANAGEMENT SYSTEM,” which application is expressly incorporated herein by reference in its entirety.

### BACKGROUND

Computer systems have impacted nearly every aspect of modern living. For instance, computer systems are generally involved in work, recreation, healthcare, transportation, entertainment, and even household management.

Computing functionality can be enhanced by interconnecting a computer system to other computer systems via one or more network connections. Some of these network connections include connections via wired or wireless Ethernet, cellular connections, or even computer-to-computer connections through serial, parallel, USB, or other connections. Such connections allow a computer system to access services at other computer systems and to quickly and efficiently receive application data from other computer systems.

Interconnection of computer systems has facilitated distributed computer systems, such as so-called “cloud” computer systems. In this description, “cloud computing” and “cloud environments” may be systems or resources that enable ubiquitous, convenient, and on-demand network access to a shared pool of configurable computing resources (e.g., networks, servers, storage, applications, services, etc.) that can be provisioned and released with reduced management effort or service provider interaction.

Cloud and remote based service applications are prevalent. Such applications are hosted on public and/or private remote systems, such as clouds, and usually offer a set of web-based services and other resources to client systems (e.g., tenants). These resources may include hardware (e.g., storage devices) for storing data, as well as virtual machines for processing the data, and various communication pipes (e.g., portals, interfaces, and communication channels) for accessing, processing, computing, and distributing the data.

Educational programs, such as grade schools, universities, trade schools, vocational schools, and athletic programs, have been relying more and more on computer systems, including cloud-based applications, to help with their instructees' learning processes. Indeed, teachers, professors, instructors, and coaches (collectively referred to herein as “instructor(s)”) are using cloud services more frequently to track and record the progress of their pupils (referred to herein as “instructee(s)”).

Although some cloud-based applications exist to help instructors and instructees, these applications are often difficult to work with, or they fail to provide adequate structure for the learning process, particularly for task-based objectives. As used herein, the phrases “task-based objective,” “task-based learning objective,” “learning objective,” or simply “task” are interchangeable phrases and generally refer to a discrete unit of work or a discrete activity that can be performed by an instructee to gain proficiency in a certain skill. One example of a learning objective is a ski drill a ski student is tasked or assigned to perform. By performing the drill (perhaps repeatedly), the ski student will improve his/her skill set and become more proficient at skiing.

One especially pronounced pain point with the above-described traditional systems is that they fail to provide instructees with immediate, contemporaneous, or instant feedback on how the instructees performed a task. Another problem with the existing technology is that there is no centralized service that can be used to document and maintain an instructee's learning progress. Yet another problem relates to the large disparity in training techniques, even within a common learning environment or program (e.g., at a ski school, the quality of training that instructors provide can vary dramatically). As such, there is a significant need to improve how task-based learning objectives are generated, provided to instructees, and then monitored.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments relate to systems, methods, and devices that generate, monitor, and assess task-based learning objectives via a learning management system.

In some embodiments, a set of trackable criteria or tasks is generated. This set is managed by a digital portfolio stored in the cloud. The portfolio is accessible by an instructee and an instructor. Performance data, which describes the instructee's performance of the criteria/tasks, is received or accessed. Additionally, assessment data, which details an assessment of the performance data, is also received or accessed. The assessment data describes how closely the instructee's actual performance corresponds with a desired performance as defined by the criteria/tasks. In some cases, the desired performance outlines a particular skill level or proficiency that should be achieved prior to the instructee being allowed to advance to a next level or to a next task. This assessment data also includes an overall ranking that describes the instructee's performance. A report is also generated. This report lists the assessment data and is rendered on a user interface. This user interface has a particular visual layout configured to display at least some of the assessment data simultaneously with at least some of the performance data. The user interface also displays the overall ranking. Based on the assessment data, the set of trackable criteria/tasks will also be modified.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates one example scenario (e.g., an athletic skiing scenario) in which the disclosed learning management systems may be implemented so as to improve task-based learning.

FIG. 2 illustrates a flow diagram of an example process performed by the disclosed learning management systems to improve task-based learning.

FIG. 3A illustrates an example portfolio utilized by the disclosed learning management systems, where the portfolio includes a plethora of information (e.g., user information, instructor information, and administrator information) that can be tethered to a particular instructee in order to guide the instructee in his/her task-based learning.

FIG. 3B illustrates an example scenario (e.g., an athletic ski-based scenario) in which each instructee is provided with, associated with, or otherwise tethered to a corresponding portfolio.

FIG. 3C illustrates how a portfolio can be continuously associated with an instructee regardless of which learning institution the instructee attends and regardless of whether the instructee switches between multiple different learning institutions or instructors.

FIG. 4 illustrates some example information that may be retained or managed within a portfolio of the disclosed learning management systems.

FIG. 5 illustrates some example information that may be included within a profile. FIG. 5 also shows that any number of profiles may be included in the learning management system, such as, but not limited to, instructee profiles, instructor profiles, and even administrator profiles (e.g., an administrator may be a learning institution or a program coordinator).

FIG. 6 illustrates some example learning objectives that may be automatically generated, recorded, and monitored/tracked by the disclosed learning management systems.

FIG. 7 illustrates how a training plan or training rubric may be automatically and/or manually generated based on certain learning objectives, where the training plan outlines a detailed progression schedule, progress plan, or progression path for an instructee to follow in order to achieve his/her learning objectives/tasks/criteria.

FIG. 8 illustrates some example performance data that may be automatically collected while the instructee works on completing a training plan. This performance data may be generated automatically and may be automatically uploaded and tagged to a particular instructee's specific portfolio.

FIG. 9 illustrates how numerous different types of data (e.g., video data, image data, audio data, text data, etc.) may be included in the performance data.

FIG. 10 illustrates how video or image content can be annotated by an instructor (or even an instructee) to provide live or real-time feedback to an instructee.

FIG. 11A illustrates an example of a progression suggestion/path flow, where an analysis engine is able to facilitate the process of analyzing performance data to determine the next steps an instructee should take to complete his/her training plan as well as how and to what extent the training plan should be modified based on the instructee's actual performance. FIG. 11A also illustrates an equipment matcher engine configured to generate customized/tailored suggestions regarding which equipment, supplies, or even programs an instructee may obtain to help his/her performance in completing a training plan.

FIG. 11B illustrates an example user interface that may be used to visually display some or all of the instructee's collected performance data as well as some or all of the instructor's real-time feedback/assessment data.

FIG. 12 illustrates an example user interface (e.g., a client or instructee portal) an instructee may use to access the benefits of the disclosed learning management systems from an instructee's perspective or point of view.

FIG. 13 illustrates an example user interface (e.g., a different portal) an instructor may use to access the benefits of the disclosed learning management systems from an instructor's perspective or point of view.

FIG. 14 illustrates one example technique (e.g., video capture) for obtaining an instructee's performance data. FIG. 14 shows how a camera can be used on a ski slope to obtain video recordings of a skier as the skier skis down the slope.

FIG. 15 illustrates how the learning management system may provide information to an instructee and/or instructor in numerous different ways, including through the use of a head-mounted device (HMD).

FIG. 16 illustrates a flowchart of an example method for implementing a learning management system.

FIG. 17 illustrates an example computer system capable of performing any of the disclosed operations.

### DETAILED DESCRIPTION

Disclosed embodiments include systems, methods, and devices that generate, monitor, and assess task-based learning objectives via a learning management system.

In some embodiments, trackable criteria/tasks/activities for an instructee is generated and managed by a digital portfolio stored in a cloud environment. Performance data, which describes the instructee's performance of the trackable criteria, is accessed and also stored in the portfolio. Assessment data, which details an assessment of the performance data, is also accessed and stored in the portfolio. The assessment data details an assessment of the instructee's actual performance as compared to a desired performance (or a defined proficiency threshold) defined by the trackable criteria (e.g., did a ski student successfully complete all aspects of a particular ski drill). A report is generated and rendered in a user interface (UI) that has a particular visual layout. Based on the assessment data, the set of trackable criteria/tasks is modified.

### Technical Advantages and Benefit(s)

The disclosed embodiments bring about substantial benefits to the technical field. In particular, the disclosed embodiments significantly improve how task-based learning is performed and monitored by providing a unique (and much needed) learning management system. This learning management system connects instructees, instructors, and administrators (e.g., the learning institution or program coordinator) in a manner that creates significant efficiency improvements. This learning management system also enables instructees to be paired with the right or most suitable instructor who is an expert in whatever field the instructee is trying to become proficient in (e.g., a skier can be matched with an instructor even before the skier goes up the mountain).

This learning management system, which may be implemented as a cloud-based application or even as a locally installed application, is configured to provide instructees with advanced learning data designed to facilitate the learning process. As used herein, the phrase “learning data” should be interpreted broadly and refers to any type of data connected, associated, or otherwise corresponding to a task-based learning process. Here, a task-based learning process refers to a process in which an instructee is assigned or tasked with completing any number of goals, objectives, expectations, activities, tasks, criteria, or milestones. By completing these objectives, the instructee will develop numerous skills, the combination or collection of which will enable the instructee to independently perform complex tasks on his/her own. The instructee's progress through these tasks can be monitored and tracked in order to provide tabulated up-to-date or real-time progress reports for instructors and instructees to view. Accordingly, a task-based learning process refers to a set of step-by-step discrete processes that, as they are completed, assist an instructee in gaining independence and expertise in a particular field of study (e.g., scholastic/educational, vocational, or even athletic fields).

By providing an intuitive user interface and information tracking portfolio, the disclosed embodiments improve how users (e.g., instructees, instructors, and administrators) interact with a computer system and improve how those users accomplish or monitor task-based learning objectives (aka performance objectives). In this regard, substantial benefits are provided to the users of the disclosed learning management system because they enable these users to obtain, work on, or otherwise utilize learning information in a highly efficient manner.

The disclosed embodiments also improve how a computer system functions (e.g., its efficiency) when performing operations related to task-based learning. That is, the disclosed portfolios are designed in a manner so as to robustly and efficiently manage an instructee's learning data. In some cases, the disclosed portfolios can be considered as a type of lifetime training and achievement resume detailing which activities an instructee has performed to reach a certain skill level. Computing efficiencies are achieved as a result of providing a unique portfolio that manages learning data in an organized and efficient manner.

Additional benefits and improvements include the availability of a computing platform configured to enable instructors to provide immediate/instant feedback to an instructee so that the instructee can immediately (or almost immediately) work on improving his/her performance during the next task. Stated differently, the disclosed embodiments enable an instructee to immediately self-correct based on feedback that is provided in real-time. Additionally, some of the disclosed embodiments provide improved coordination between instructees, instructors, and administrators, as will be discussed in more detail later. As used herein, the term “administrators” refers generally to the learning institution where an instructee is receiving instruction or perhaps even to the program coordinator(s) at the learning institution. Examples of a learning institution include, but are not limited to, a school, university, athletic department or location (e.g., a ski lodge or resort), and so on. Administrators can provide scheduled services to allow instructees and instructors to connect with one another. Administrators also provide facilities and/or equipment. Accordingly, use of the term “administrator” should be interpreted broadly. An additional benefit relates to the ability to generate a report, alert, or notification regarding feedback that is provided to an instructee. Such alerts constitute a concrete, practical application by which the disclosed embodiments benefit the users and the technology.

### Examples of Learning Environments

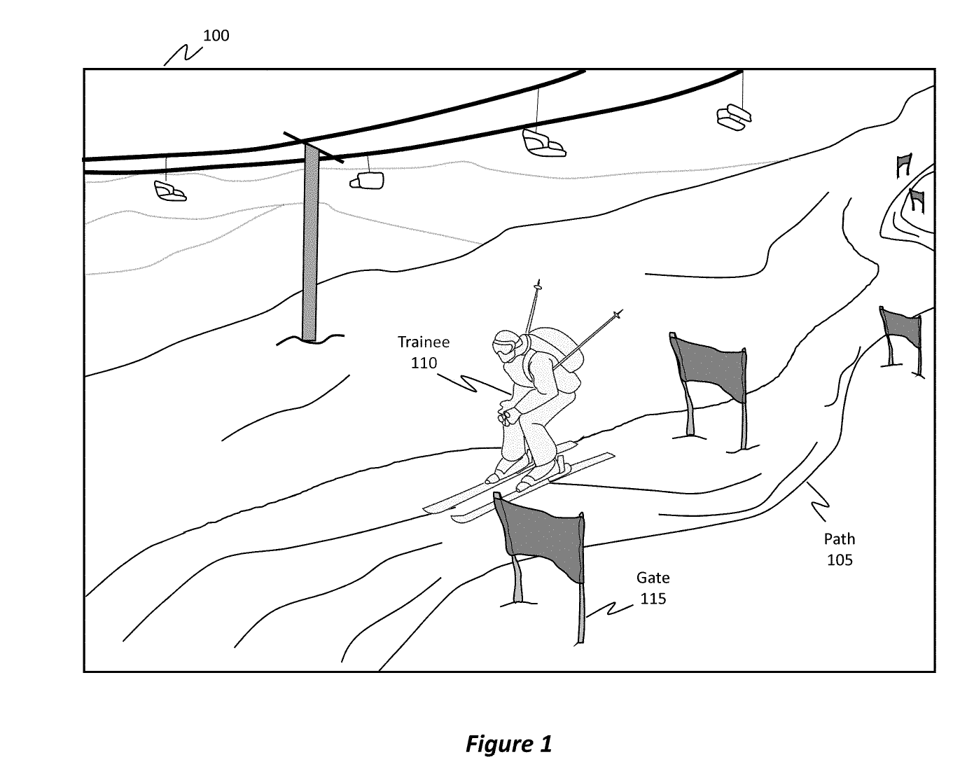

Attention will now be directed to FIG. 1, which illustrates a mountain environment 100 that includes a ski path 105 (or slope). Here, a ski trainee 110 (e.g., an example of an instructee) is skiing down the ski path 105 past any number of gates (e.g., gate 115). This mountain environment 100 illustrates one example scenario in which an instructee (e.g., ski trainee 110) is assigned to perform a number of different tasks (e.g., ski drills) so as to improve the instructee's competence in the field (e.g., the skiing field). While FIG. 1 and many of the remaining figures focus on a ski-based learning environment, the embodiments should not be limited only to these types of environments. Indeed, the disclosed principles may be practiced in any type of task-based learning environment such as, but not limited to, grade schools, universities and colleges, trade schools or vocational schools, and any other type of sporting environment (e.g., golf, tennis, basketball, etc.).

With regard to these learning environments, the disclosed principles may be practiced for novice instructees, intermediate instructees, and advanced instructees. Additionally, the disclosed principles may be practiced for competitive activities (e.g., racing scenarios) or non-competitive activities (e.g., recreational learning). The disclosed principles may also be practiced for professional activities, for amateur activities, and even for instructors or other personnel seeking to obtain a certification or license to practice. As an example, the snow sporting industry can use the disclosed embodiments to monitor certifications and even to conduct certifications of snow sport instructors. Accordingly, from this disclosure, it will be appreciated that the disclosed embodiments may be practiced in any type of environment or setting, and they should not be limited only to ski-based activities. For brevity purposes, however, the remaining figures and examples will focus only on a snow sport learning environment.

One of the problems with traditional learning in the snow sports industry is that, when an instructee (e.g., a competitive athlete or a non-competitive student) is learning or training in a sport, the instructee was previously not able to get instant feedback on the snow slope nor could the instructee immediately see him/herself in the activity. In some cases, only oral feedback was provided long after the instructee's performance of an activity.

In some traditional cases, instructors do use a video recording to monitor the instructee's activities, but those videos were not associated, attached, or tethered to an instructee in any manner. For instance, what would typically occur in the snow sporting industry was that an instructor would record multiple instructees completing an activity. Once all of the activities were complete, then the instructees and instructor would meet in a group room, and the videos would be played on a screen for everybody to view. Each instructee would have to wait until his/her own video was played, and each instructee would have to wait to receive feedback. As a result of this dynamic, the instructee was not able to immediately receive feedback, nor was the instructee able to perform immediate correction on the next ski run, if needed. As will be discussed in more detail later, the disclosed embodiments solve this need as well as many others by configuring a portfolio that is tethered to an instructee and that can be used to manage all of the instructee's learning and performance data.

### Learning Management System Flow

The disclosed embodiments are related to a learning management system that allows a uniquely customized portfolio to be associated with an instructee or even to a team of instructees. With this portfolio, the instructee is able to connect to his/her instructor as well as to whatever administrator the instructee/team is currently using. Furthermore, even if an instructee switches instructors and/or administrators, the portfolio will still be associated or tethered to the instructee and will still retain the instructee's learning and performance data. In this regard, the portfolio is highly flexible and allows for migration across administrators and instructors. Any information included within the instructee's portfolio can be reference by the instructee at any time and for any reason in order to continuously build progression the next time he/she trains. Accordingly, the disclosed embodiments provide a centralized service that can be used to standardize the learning industry (to be discussed in more detail later) and that can be used to record, document, and maintain an instructee's learning progress.

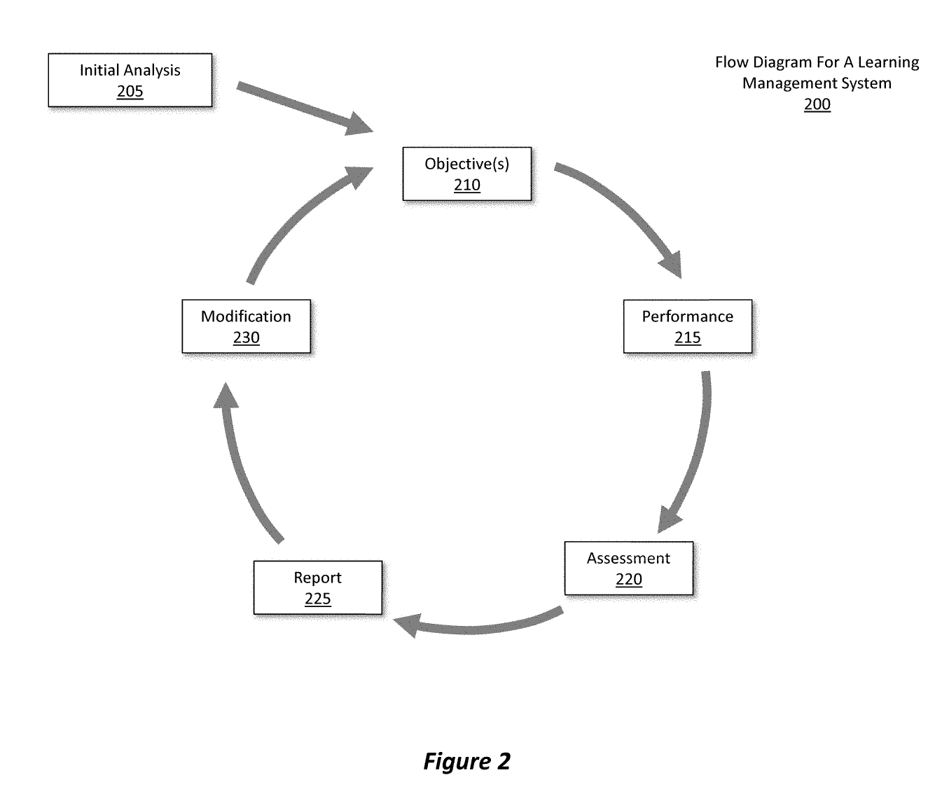

Attention will now be directed to FIG. 2, which illustrates a flow diagram for a learning management system 200. This flow diagram outlines some of the general processes that are followed by the disclosed learning management systems in order to achieve the benefits described earlier. Furthermore, a computer system implementing the learning management system may be used to perform these flow processes. FIG. 2 introduces these flow processes at a high level. Subsequent figures will be used to delve more deeply into each of these concepts. It will be appreciated that these principles may be applied for an individual instructee or even to a team of instructees. As such, the disclosed embodiments are applicable to any number of instructees and/or teams.

Initially, the flow includes performing an initial analysis 205 for an instructee. With reference to the snow sport example, a ski instructor may ask a ski instructee to ski down a slope in order to obtain an initial understanding of the instructee's current skill level. Any information derived or obtained as a result of the initial analysis 205 may be automatically collected and/or manually entered into the learning management system. By way of a brief example, any video clips, images, audio clips, or notes can be automatically uploaded into the learning management system.

Once the initial analysis 205 is complete, then the instructee and the instructor can commune to determine a set of learning objectives 210. These learning objectives 210 may include any type of goals, milestones, desired outcomes, criteria, tasks, or desired skill levels. For instance, a novice ski instructee may desire to ski or snowboard down a mountain at a competitive skill level. Together, the instructee and instructor are able to discuss and generate the learning objectives 210 and upload them into the learning management system. In some instances, a set of predetermined learning objectives may already be provided by the learning management system in the form of a template.

As an example, a novice template, an intermediate template, and an advanced template may be available before any instruction occurs. These templates may be stored by the learning management system and may be made available when drafting the learning objectives 210.

Included within this flow process is the development of a training plan, a training rubric, or a training management plan. The training plan is provided in order to establish/schedule specific milestones, tasks, activities, and goals that, if achieved, will lead to the satisfactory completion of the learning objectives 210.

The training plan may be a plan having milestones, expectations, or desired performance levels spread out throughout an extended period of time (e.g., an entire season) or it may have milestones spread out throughout a much shorter period of time (e.g., a single run down a mountain, a single hour, or a single day). For instance, in the snow sporting industry, a program coordinator or head coach is able to create an entire training plan for the whole season or, alternatively, possibly for a much shorter period of time.

The head coach can log in to the learning management system, select a particular instructee or even a team or group of instructees, and then generate plans for a determined period of time. If the training plans are already generated, then the head coach can access them and select the next task-based activity for the instructee to work on. The instructees will then be tasked with accomplishing the different drills and lesson plans so as to continually improve their skill sets. The training plan may indicate that it is desirable for the instructee to achieve a certain threshold proficiency or performance proficiency in a particular criteria/task/objective prior to the instructee being allowed to proceed on to the next criteria. For instance, if a ski student is characterized as a novice in a particular activity, the training plan may indicate that the ski student is required to become an intermediate in that particular activity prior to the ski student progressing or advancing on to a next level or a next drill, task, or activity. In this regard, a set of tasks or criteria may outline or may require a desired performance level or proficiency that should be achieved prior to the instructee advancing forward.

Accordingly, the disclosed learning management systems are configured to provide training management plans to instructees. The learning management systems also provide any number of assessment tools (to be discussed in more detail later) that can be used to assess activities the instructee is engaged in. In some cases, these tools are provided on a mobile device such that the instructor and/or instructee can view, interact, or use the assessment tools. The assessment data is then tethered or associated with the specific instructee. As one example, metadata of the assessment data or even of the performance data can be tagged or modified to include a field in which the instructee is identified. A filtering or sorting algorithm can then be used when the data is uploaded to ensure that the data is correctly associated with the instructee (e.g., by being placed in the instructee's corresponding portfolio) based on the tagged metadata.

By way of an additional example in the snow sports industry, the Professional Ski Instructors of America (PSIA) has a handbook detailing approximately 125 different training (e.g., Alpine Discipline Training) drills for instructees to complete. The above-described training plan can be configured to include any number and/or combination of the 125 drills. These drills can be spread throughout the instructee's schedule and the instructee can work on accomplishing those drills in a progressive, task-based manner. Furthermore, as will be described in more detail later, any performance data (e.g., videos, images, audio clips, notes, etc.) generated as a result of the instructee performing those drills can be automatically uploaded to the learning management system and tethered or otherwise associated with the instructee by storing that information in the instructee's personalized portfolio. In this regard, the learning management system can operate as a tracking mechanism to monitor and record the instructee's progress as he/she completes the training plan.

It should be noted that the learning management system is accessible via numerous different types of devices, some of which are mobile devices (e.g., a phone, watch, head-mounted device (HMD), or tablet). Because of this portability, an instructee can readily view his/her training plan on the mobile device as well as any feedback from the instructor.

For instance, as the instructee is riding a ski lift up the mountain to start another run, the instructee can consult his/her training plan to see which specific tasks are listed next. Furthermore, as will be described in more detail later, the instructee can see and review the instructor's feedback using the mobile device as well. Accordingly, the instructee and instructor can discern how the instructee is performing against the training plan in an easy manner by simply consulting the mobile device. The instructor and even the administrator can view the instructee's progress and can monitor this progress from start to finish. They can also determine whether the current training plan is working well for the instructee or whether the training plan should be modified. Thus, the instructee can progress at a customized pace of learning.

The next process in the flow diagram for the learning management system 200 is actual performance 215 by the instructee of tasks/criteria included within the training plan. As an example, the training plan may dictate that a ski instructee is to perform any number of drills on a mountain throughout the course of a day, a week, or even a season.

The flow diagram next shows an assessment 220 step in which the instructee's performance 215 is assessed (e.g., by the instructor or even automatically by the learning management system). By performing this assessment 220, the instructor (or the learning management system) is able to provide immediate feedback to the instructee so that the instructee can work on improving his/her performance of the next task. Additionally, the instructee can immediately consult with the instructor when reviewing the feedback, thereby providing a feedback loop between instructee and instructor.

In some cases, a report 225 may be generated, where the report 225 details the instructee's performance and how it can be improved. If needed, a modification 230 can then be performed against the training plan. For instance, if the instructor determined that the instructee was deficient in a particular skill, then a modification 230 can be made against the training plan to alter the plan so that additional emphasis is placed on satisfactorily obtaining the particular skill. In this regard, a training plan can continuously evolve based on the needs and performance of the instructee. Accordingly, FIG. 2 illustrates a generalized flow diagram of some of the processes that are followed by the disclosed learning management systems.

### Learning Management Portfolio

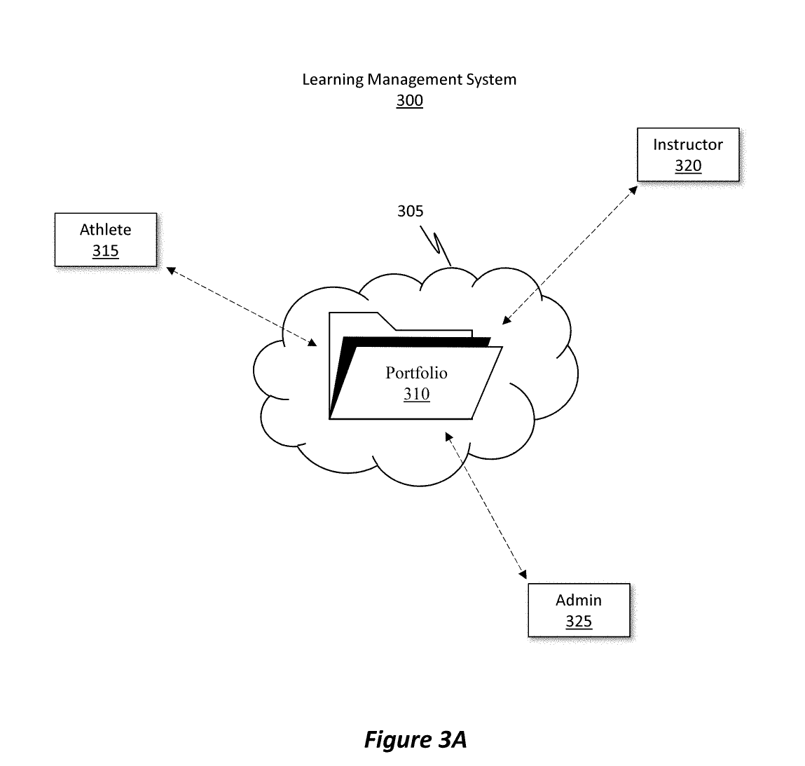

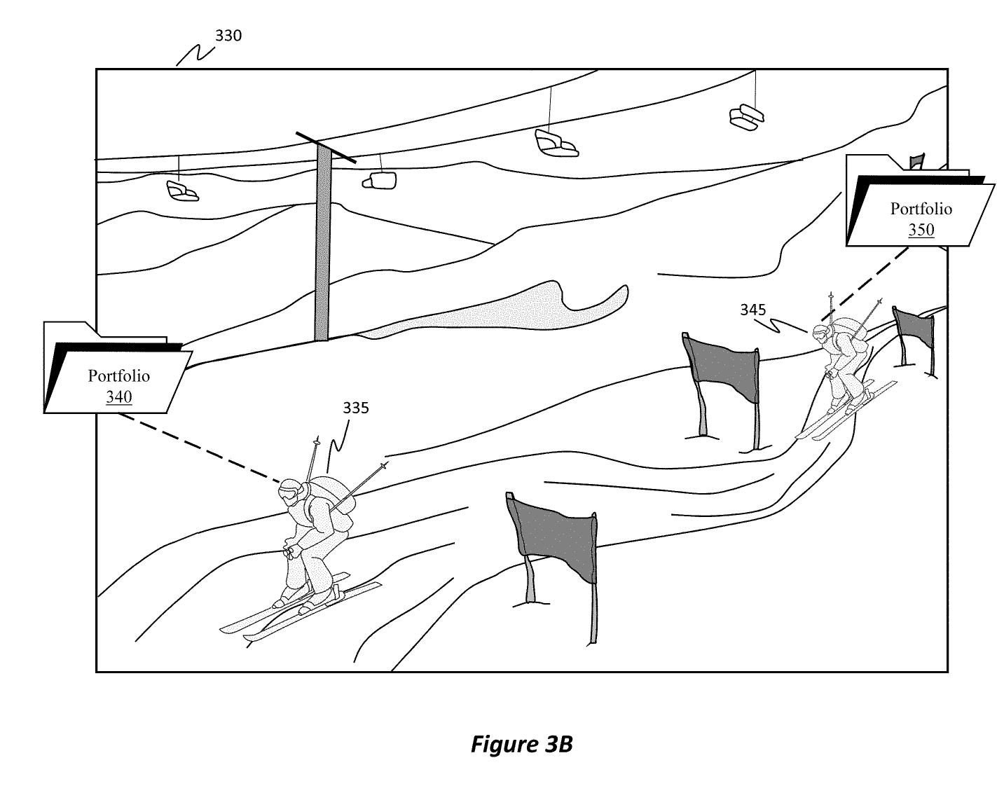

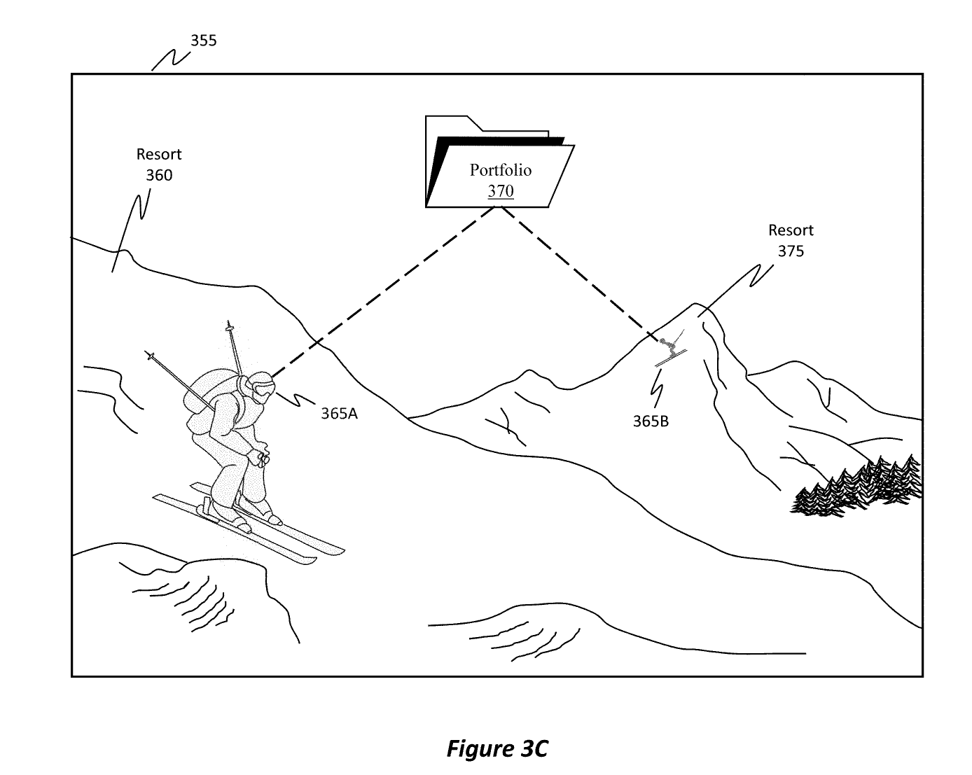

FIG. 3A illustrates an example of a learning management system 300 in accordance with the disclosed embodiments. In some implementations, learning management system 300 is implemented as a cloud-based service operating in the cloud 305. In other implementations, learning management system 300 is a standalone application that may be installed on a user's mobile device.

Learning management system 300 is configured to include any number of portfolios (e.g., portfolio 310) used to track, monitor, and record an instructee's learning data. This learning data may include any kind of data associated with the instructee's task-based learning process. Examples of this learning data include, but are not limited to, the instructee's performance data, the instructor's (or the learning management system's) feedback and notes (i.e. assessment data), the learning objectives, the training plan, and countless other types of information, as will be described in further detail later.

In some cases, multiple entities are able to obtain access to portfolio 310. For instance, FIG. 3A shows that an athlete 315 (i.e. an instructee), an instructor 320, and an administrator 325 are all able to access the portfolio 310. In some cases, learning management system 300 includes multiple client portals or access points for these different entities to access the portfolio 310.

As an example, athlete 315 may be provided with one type of client portal (e.g., an instructee portal) used to access portfolio 310. Instructor 320 may be provided with another type of client portal (e.g., an instructor portal) used to access portfolio 310. Furthermore, administrator 325 may be provided with yet another type of client portal (e.g., an administrator portal) used to access portfolio 310. These different client portals may be configured in separate ways depending on the needs of each entity. For instance, while administrator 325 may be interested in monitoring data related to the overall maintenance and care of its training facility (e.g., the number of skiers at a resort or the number of skiers using a particular slope), the athlete 315 may not be interested in that particular type of data. Consequently, the information provided by each of the different client portals may be somewhat different, yet the information may all be retained within portfolio 310.

It will be appreciated that each instructee is provided with his/her own portfolio. These portfolios may be stored in the cloud and may be accessible via any type of communication mechanism (e.g., wireless network, cell network, ethernet connection, and so on). To preserve each instructee's privacy, isolation may be provided between each portfolio such that one instructee is not able to access the portfolio of another instructee unless authorization is provided.

Regarding the athlete 315, instructor 320, and administrator 325, it will be appreciated that these terms should be interpreted broadly. For instance, athlete 315 may be any kind or type of instructee and should not be limited simply the kinesthetic-type instructees. For instance, athlete 315, or rather “instructee,” can be a grade school student, a university or college student, a technical or vocational school student, a professional or novice athlete, or any other type of instructee who is performing task-based learning.

On a similar note, instructor 320 can be any type of instructor and is not limited simply to athletic roles. For instance, instructor 320 can be a grade school teacher, a college or university professor, a technical or vocational instructor, or even a coach.

Administrator 325 should also be interpreted broadly. Administrator 325 can be a grade school with its faculty, a college or university with its faculty, a technical or vocational school with its faculty, or an athletic department with its faculty. Administrator 325 may also be a program coordinator. Administrator 325 may be interested in learning how its equipment and resources are being used collectively by numerous students and/or it may be interested in learning how its equipment and resources are being used by individuals. Through use of the learning management system 300, the administrators 325 will be able to obtain analytics and other metrics with regard to the use, wear-and-tear, and other factors related to their facilities and equipment.

In some cases, administrators 325 can use the disclosed embodiments to generate or obtain information about instructional processes, instruction quality, student comprehension, student caliber and quality, and even methodology and instructee retention. In this regard, administrators 325 can benefit from obtaining analytics, metrics, quality indicators, and quantitative assessment data about numerous different factors. Additionally, the disclosed embodiments enable administrators 325 to not only monitor student levels, but they also enable administrators 325 to monitor the instructors, including those instructors' teaching qualities and abilities. Such monitoring allows the embodiments to ensure that a same level of teaching quality is being performed among any number of different instructors, which was a problem with traditional instruction techniques (i.e. different instructors taught at different levels of quality). Accordingly, student data as well as teacher/instructor data may be collected and managed by the disclosed embodiments. This data may be analyzed to learn the trends, patterns, and behaviors of both students and instructors. The resulting analytics can then be used to help improve student learning and teacher instruction.

To recap, the disclosed embodiments provide greater insight, control, standardization, and authenticity of instructors' instructional qualities. The disclosed embodiments also provide improved instructional methodology, delivery, assessment, and analysis for instructees. Even further, the disclosed embodiments provide a personalized performance development curriculum with increased learning outcome attainment and mastery of skills.

Another benefit provided by a centralized learning management system is the ability to standardize the training as between multiple students/instructees. Using the snow sporting industry as an example, in the past, the training process was not standardized. Instead, instructors would develop their own lesson plans and course objectives and then task the instructees with performing these objectives. As a result of this dynamic, the level and quality of training between instructors and even ski schools varied dramatically.

By consolidating and managing the training regimen within a centralized learning management system, the disclosed embodiments are able to provide uniformity and standardization to whichever task-based learning program the embodiments are being applied to. For instance, the disclosed embodiments are able to standardize the snow sporting industry as a result of providing predictability and uniformity between instructors and ski schools (i.e. administrators). To help instructors in their teachings, the disclosed learning management systems can provide reminders or prompts to the instructors to ensure that they mention or suggest certain drills or talk about certain training aspects.

FIG. 3B shows the portability of the learning management system, and in particular the portability of the portfolios discussed above. Specifically, FIG. 3B shows another learning environment (e.g., mountain environment 330) where a first skier 335 is associated with a first portfolio 340 and where a second skier 345 is associated with a second portfolio 350. To be more precise, portfolio 340 is skier 335's own specific portfolio, and portfolio 350 is skier 345's own specific portfolio. In this regard, portfolios can be tethered or otherwise associated with individual instructees. The portfolios can be accessed via any type of mobile device using the instructee's corresponding username and password.

FIG. 3C shows another learning environment (e.g., mountain environment 355) that includes a ski resort 360. Here, a skier 365A, who is associated with portfolio 370, is shown as using the resources of the ski resort 360. At a different time, however, skier 365A may decide to switch ski resorts or ski schools. For instance, FIG. 3C also shows skier 365B, who is representative of skier 365A but who is now skiing at a different ski resort 375. As shown, the skier's portfolio 370 can stay with the skier regardless of which ski resort the skier is currently using.

By attaching a portfolio to an instructee (e.g., an instructee can use a username and password to thus gain access to the portfolio at any location), new or different ski instructors can be made immediately aware of the skier's current skill level. As an example, some embodiments are configured to generate a snapshot view of an instructee's performance data and/or performance level. This snapshot view is a compressed description that highlights, or rather outlines, the instructee's skill level. The embodiments are able to provide this snapshot view to an instructor, thereby enabling the instructor to quickly and efficiently determine the instructee's skill level. As another example, a ski school can be made aware of the incoming student's performance level with a performance snapshot that links and/or displays past learning achievements. This snapshot creates and/or builds learning progression in the student that facilitates a continuous learning path.

By having the instructee's information at hand, new instructors (e.g., when the skier switched ski resorts, the skier may also have switched instructors) will not need to spend nearly as much time becoming acquainted with the skier's skill level. Consequently, the skier can begin receiving instruction much faster and progress at a faster rate. Accordingly, it will be appreciated that a portfolio may be associated with an instructee and may follow the instructee wherever he/she receives instruction. This portfolio may be stored in the cloud and may be accessible to any number of entities, depending, of course, on the security/privacy measures associated with the portfolio (e.g., access restrictions may be provided to restrict certain entities from obtaining access to the instructee's learning data).

### Example(s) of Portfolio Information

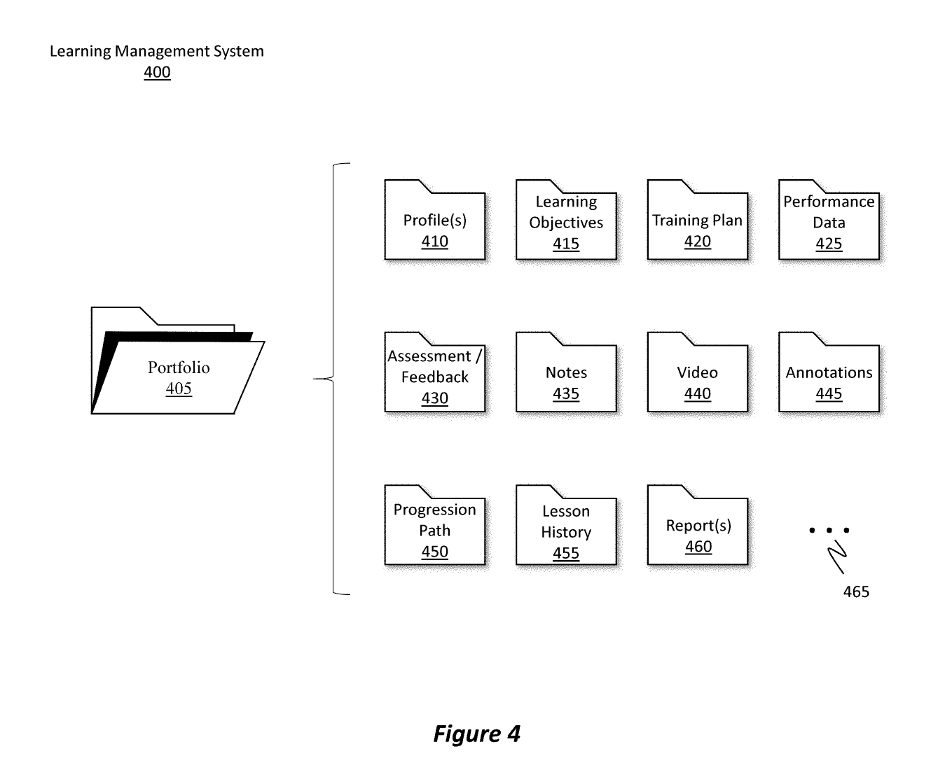

FIG. 4 shows another learning management system 400, which is representative of learning management system 300 from FIG. 3A. FIG. 4 also shows how learning management system 400 includes a portfolio 405, which is also representative of any of the portfolios discussed thus far. Portfolio 405 may be considered as a compilation of some or all of an instructee's learning data. The disclosed learning management systems are able to automatically generate a log and/or capture the activities of the instructee and automatically populate the portfolio 405 with this captured data so that minimal manual input is performed on the instructee or instructor's parts.

Portfolio 405 may be used to track and record any amount of information pertaining to an instructee's task-based learning objectives and his/her progression through those task-based learning objectives. FIG. 4 illustrates some examples of what may be managed by the portfolio 405. It will be appreciated, however, these that are examples only and should not be considered limiting or binding.

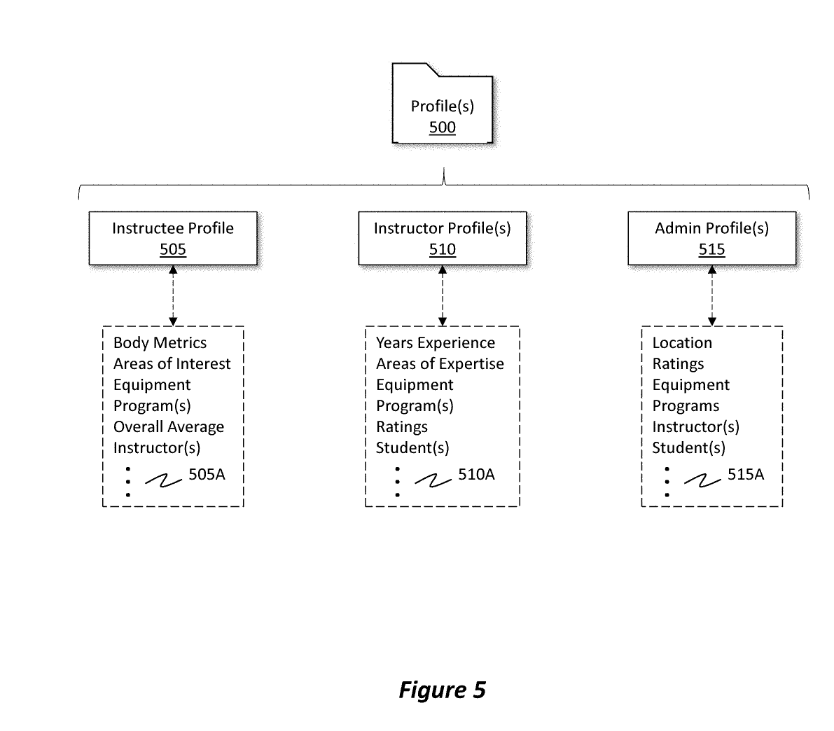

Initially, portfolio 405 is shown as including one or more profile(s) 410. Profile(s) 410 can be used to track and record the information for a particular instructee and for any instructors the instructee uses and/or for any administrators the instructee is associated with (e.g., what facility the instructee uses). FIG. 5 provides further clarification on some of the information that may be included within profile(s) 410.

Specifically, FIG. 5 shows profile(s) 500, which is representative of profile(s) 410 from FIG. 4. In this scenario, profile(s) 500 include an instructee profile 505, one or more instructor profile(s) 510, and one or more administrator profile(s) 515. Because of the portability and flexibility of the disclosed learning management systems, a single instructee may be associated with any number of instructors and/or administrators. As an example, consider a grade school learning environment. Here, a single student may have 1, 2, 3, 4, 5, 6, or any number of teachers throughout the day. As such, instructor profile(s) 510 may be configured to include descriptive information for each one of the potentially many teachers for the student.

FIG. 5 shows some of the information that may be included within the instructee profile 505. Specifically, this information may include, but is not required to include, body metrics (e.g., describing the height, weight, flexibility, and other factors of the instructee's physical body), areas of interest (e.g., is the snow sport athlete interested in snowboarding, skiing, cross country activities, etc.), and equipment (e.g., the specific type of equipment the instructee is currently using). Instructee profile 505 may also include the instructee's overall average score in completing one or more tasks or objectives. This overall average score can be a generalized score for the individual or it can be a scaled score based on a relative measurement compared to a group of other instructees. Further details on scores and averages will be provided later. Instructee profile 505 may also list the instructee's previous, current, and/or future-planned instructors. The ellipsis 505A demonstrates that other information may be included in instructee profile 505.

Instructor profile(s) 510 may also include a wealth of information. For instance, this information may include the number of years of experience the instructor has, the instructor's areas of expertise, what equipment the instructor uses or most often recommends, and which program(s) the instructor teaches. Additional profile data may include an instructor history, instructor professional training data, and/or even student performance data.

The instructor profile(s) 510 can also include ratings metrics. For instance, if instructees particularly like the instructor, then they can give the instructor a high rating. If the instructees do not like the instructor, then they can give the instructor a low rating. In this regard, the ratings can assist prospective instructees in determining whether they would like to hire the services of a particular instructor. The ratings are available to instructees to review and consider.

Similar to this rating feature, the disclosed learning management systems also allow instructees to reward their instructors financially via a tipping feature. That is, the learning management systems enable instructees to tip their instructors. Additional details on this feature will be presented later. By way of a brief introduction, however, instructors may be paid by the administrators, but they may also obtain additional funding from the tipping option.

Instructor profile(s) 510 may also list which students an instructor has previously worked with, is currently working with, or will soon work with. The ellipsis 510A demonstrates that other information may be included in instructor profile(s) 510 as well. Some of this other information may include instructional data of instructees, financial tipping information, which drills were performed and/or taught, which locations the drills were performed, and so on.

The administrator profile(s) 515 may include any educational quality information pertaining or relating to the facilities at which the instructee is stationed. Example types of educational quality information included within administrator profile(s) 515 include, but are not limited to, the location of the facilities, the likeability ratings of the facilities, the equipment available at the facilities, the programs available at the facilities, the instructors who work there, and perhaps even information related to the instructees who use the facilities. The ellipsis 515A demonstrates that other information may be included in the administrator profile(s) 515 as well.

Profile(s) 500 may be visually displayed on a user interface (e.g., any of the client portals or user interfaces discussed earlier). That is, instructee profile 505, instructor profile(s) 510, and/or administrator profile(s) 515 may be provided to a user (e.g., an instructee, instructor, or administrator) by way of a user interface displayed on a computer system. Examples of user interfaces will be provided later.

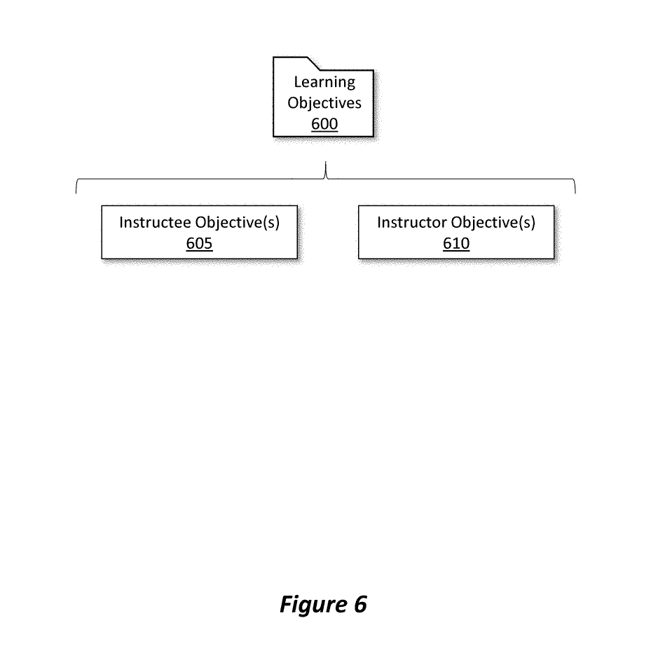

Returning to FIG. 4, portfolio 405 is also shown as including information relating to an instructee's learning objectives 415. These learning objectives 415 may include goals, milestones, tasks, criteria, activities, or desired outcomes that the instructee would like to accomplish, as described earlier in connection with FIG. 2. With reference to the snow sporting example, the learning objectives 415 may include an indication that a novice skier would like to become proficient at a particular skill or become proficient on a particular scope. FIG. 6 provides additional details regarding learning objectives 415.

Specifically, FIG. 6 shows learning objectives 600, which is representative of learning objectives 415 from FIG. 4. Here, learning objectives 600 may include either one or both of instructee objective(s) 605 and instructor objective(s) 610. Examples of instructee objective(s) 605 include goals, tasks, or criteria that the instructee would specifically like to accomplish in his/her task-based learning process. For instance, a welding student may desire to become proficient at performing gas metal arc welding. A ski student may desire to become proficient on a particular mountain or slope. Based on the instructee objective(s) 605, the instructor may also outline one or more instructor objective(s) 610 that the instructee should perform in order to accomplish the desired outcome. It will be appreciated that both the instructee objective(s) 605 and the instructor objective(s) 610 may be stored in the cloud and may be accessible at any time.

Returning to FIG. 4, portfolio 405 is also shown as including a training plan 420. This training plan may be developed by an instructor based on the learning objectives 415 or, alternatively, the learning management system may automatically and autonomously develop the training plan 420. Once developed, then the learning management system may provide the training plan 420 to either the instructor or instructee for refinement or modification. In some cases, the learning management system includes a repository of training plan templates (i.e. initial outline training plans that list some core/baseline tasks). In some cases, the learning management system includes a repository of previously-used training plans that may be used for other instructees as well.

As used herein, training plan 420 generally refers to a set of one or more tasks, activities, or criteria that an instructee (and perhaps also an instructor who is involved in the process) is to complete in order to achieve a desired end result. These tasks may be scheduled throughout the course of an established time period (e.g., a day, a week, a season, or even multiple seasons). As the instructee completes each task in the training plan 420, then the instructee will continually progress and gain skill in the area of learning. As the instructee works on completing the tasks, the instructor can provide immediate feedback to the instructee so the instructee can work on immediately improving his/her performance, as described earlier in connection with FIG. 2. Additionally, in some cases, the learning management system may periodically provide reports detailing the instructee's individual performance, or even his/her performance as compared to a group of other instructees. If needed or desired, then the training plan 420 can be modified. For instance, if the instructee fails a particular task, the training plan can be modified to cause the instructee to repeat the task until he/she competently completes the task. In this regard, the learning management system allows for the dynamic modification of the training plan, where the modifications are specifically performed based on the instructee's actual performance.

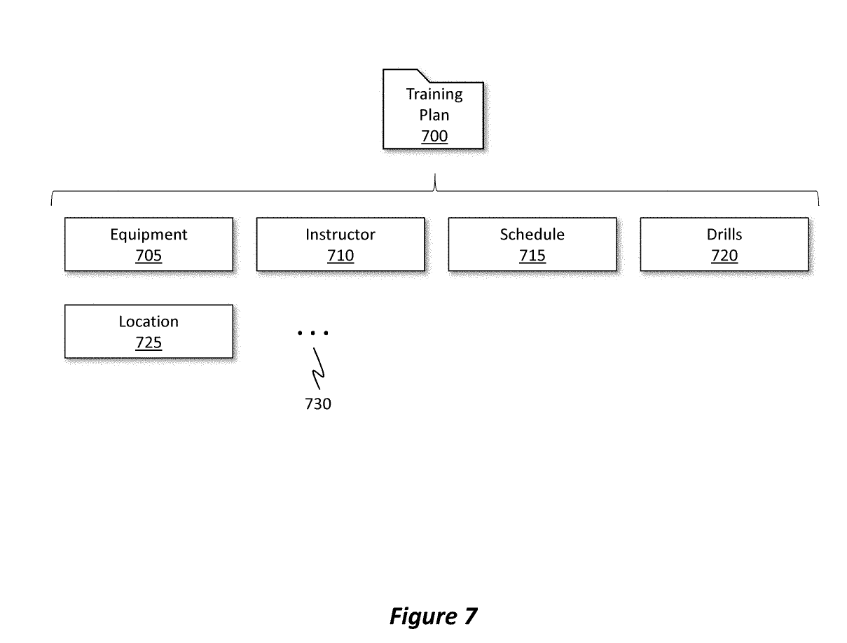

FIG. 7 shows a training plan 700, which is representative of training plan 420 from FIG. 4. Here, training plan 700 outlines some equipment 705 the instructee might consider using (i.e. a recommendation provided by the disclosed embodiments) in order to complete the tasks. For instance, in the snow sporting industry, a skier cannot ski down a mountain unless he/she has at least a pair of skis. Consequently, equipment 705 may list the instructee's current equipment, any equipment the instructee will need, and also any equipment or equipment type that may be recommended to complete a particular task.

Training plan 700 also lists an instructor 710 who is qualified to instruct an instructee in completing the tasks. In some cases, a single instructor may be adequate to train an instructee while in other cases multiple instructors may be used.

The training plan 700 can also automatically develop a schedule 715 of learning activities the instructee may follow to achieve the learning objectives. Schedule 715 may automatically populate or determine compatible times between the instructee and the instructor. Schedule 715 may schedule the day and time of day when the lesson is to occur as well as its duration. Schedule 715 may also automatically make reservations at the administrator's facilitates, and schedule 715 may even automatically rent any equipment the instructee may need to accomplish the scheduled tasks. Accordingly, schedule 715 can use information queried from the instructee's portfolio to schedule activities and services so the instructee can progress through the training plan 700.

The training plan 700 may include any number of drills 720, tasks, criteria, or activities the instructee should perform. As described earlier, the PSIA in the snow sporting industry includes around 125 separate drills which, if followed, will provide a strong basis for advancing an instructee's proficiency. As such, drills 720 may include any number of tasks, criteria, or activities designed to help the instructee progress through the training plan 700.

Additionally, training plan 700 may include the location 725 where any training or instruction is to take place. As an example, on Mondays, the instructee may visit one facility while on Tuesdays the instructee may visit another location. Consequently, the schedule 715 may detail the location 725 where any instruction is to occur. The ellipsis 730 demonstrates how other types of information may be included in the training plan 700.

Returning to FIG. 4, the portfolio 405 may also include an instructee's actual performance data 425. This performance data 425 can be captured automatically and can be automatically uploaded or included in the portfolio 405. In some cases, the performance data 425 may include one or more video clips capturing the instructee while the instructee was performing one or more criteria, tasks, activities, or objectives included within a set of trackable criteria, tasks, activities, or objectives.

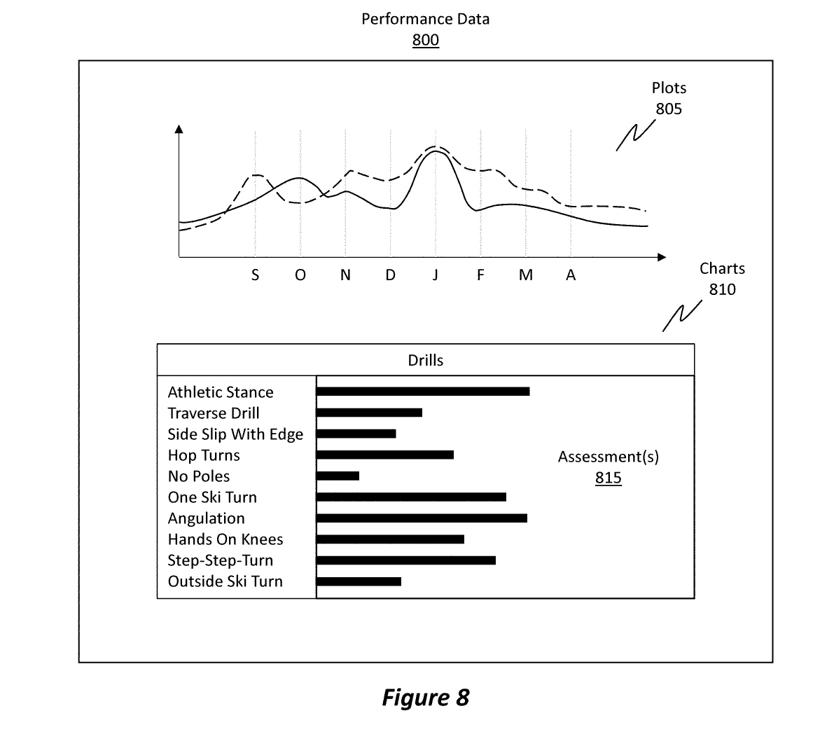

FIG. 8 provides an example of performance data 800, which is representative of performance data 425. It will be appreciated that the contents of FIG. 8 are provided for example purposes only and should not be considered limiting or binding. Performance data 800 may be collected by any means such as, but not limited to, video recording device, image recording devices, oral/audio recording devices, text input, and/or any other type of monitoring equipment. For instance, a stopwatch or other timing mechanism may be used to monitor an athlete's performance. With reference to a ski slope scenario, a timing mechanism may be used to time a skier's run and a global positioning system (GPS) may be used to monitor his/her location on the slope. Similarly, sensors included in the slope's gates can produce data to determine the relative location of the skier relative to the gate. Other types of data acquisition devices may be used as well (e.g., inertial measurement units, accelerometers, gyroscopes, head tracking or head mounted cameras, external cameras, GPS, and so on). Any type of data collected while the instructee performs an activity may be included in the performance data 800.

Performance data 800 may include any number of plots 805 visually plotting or graphing (e.g., on a user interface) the instructee's performance (e.g., the performance data, such as timing data, form or balance data, etc.) over a defined period of time. In some cases, the plots 805 can show the instructee's performance as compared to a baseline metric while in other cases the plots 805 can show the instructee's performance as compared to other, similarly situated instructees. In this regard, the instructee can be provided with a relative measurement or depiction of how the instructee is faring as compared to others. It will be appreciated that the performance data 800 may be visually rendered within a user interface through which the instructee can drill or navigate down into his/her own performance data. That is, the instructee may be provided with different levels of granularity in how his/her performance data is visually rendered. By manipulating the user interface, the instructee can see more or less detailed information.

Performance data 800 may also include any number of charts 810 that provide or that illustrate an assessment 815 of the instructee's performance, where the assessment 815 is provided by an instructor or perhaps automatically by the learning management system (e.g., via machine learning). In accordance with the disclosed embodiments, the instructor (or learning management system) is now able to provide immediate (or near immediate) feedback and assessment to an instructee. As such, when the instructee begins to work on the next subsequent task, the instructee can try to adopt the instructor's feedback, thereby leading to improved performance.

As an example, consider a ski instructee receiving instruction at a ski school. Here, the ski instructee can perform a run down the mountain and the instructor can gauge the performance of the instructee. Once the run is complete (or even while the run is occurring), the instructor can enter immediate or contemporaneous feedback into the learning management system. Consequently, as the ski instructee is riding the ski lift back to the top of the mountain, the ski instructee can review the feedback and try to adopt the teachings in the next run. Such improved training techniques enable the ski instructee to readily work on improving his/her form as opposed to having to wait until the end of the day to receive feedback and instruction. Furthermore, this feedback is retained within the learning management system so the instructee need not worry about forgetting the instruction later on.

In the example of FIG. 8, the instructor (or the learning management system) assessed the instructee in multiple different areas. For example, assessment 815 includes evaluations on athletic stance, traverse drill, side slip with edge, hop turns, no poles, one ski turn, angulation, hands on knees, step-step-turn, and outside ski turn. These different categories (e.g., athletic stance, traverse drill, etc.) can be considered “learning areas.” In this regard, a user interface can be configured to display one or more learning areas and a corresponding score, rank, or assessment for each one of the learning areas.

In some cases, assessment 815 may include a numerical score describing how competent the instructee was in performing the task (e.g., athletic stance, traverse drill, etc.). Of course, the range of the numeric score can be set to any range. Examples include ranges between 0 and 5, 0 and 10, 0 and 100, and so on. Relatively higher numeric scores may indicate a higher level of competence while relatively lower numeric scores may indicate a lower level of competence, or vice versa.

In some cases, assessment 815 may include an alphabet rating, such as a rating of “A,” “B,” “C,” “D,” or “F,” where a score of “A” indicates a high level of competence and a score of “F” indicates a poor level of competence. Of course, other alphabet ratings may be used as well.

In some cases, assessment 815 may include descriptive text, such as, but not limited to, phrases like “apprehensive,” “measured,” “relaxed,” or “aggressive.” Other phrases may be used as well. That is, any standardized set of phrases may be used to describe an instructee's level of competency. With reference to FIG. 2, it will be appreciated that these alphanumeric ratings may be used during the initial analysis 205 as well as during any subsequent performance 215.

In some embodiments, the assessment/evaluation may include the instructor or a machine learning algorithm comparing the instructee's performance to the performance outlined in the training plan. As an example, the instructee's performance can be measured against the PSIA's 125 different training drills to determine whether the instructee is performing adequately and/or progressing. The resulting data from the evaluation can be provided as analytics that may be delivered to the different interested parties (e.g., the instructee, the instructor, the administrator, etc.). In some cases the performance of one instructee can be compared against the performance data of another instructee or even of a group of instructees. This evaluation allows the embodiments to provide a relative score of the instructee as compared to other instructees. When performing the evaluations, the instructor is able to provide annotations and other feedback, which can be transmitted to the instructee immediately.

Returning to FIG. 4, portfolio 405 may also include any assessment/feedback data 430 provided by an instructor. As described earlier, this assessment/feedback data 430 may be provided immediately (or near immediately) subsequent to (or even during) the instructee's performance of a task-based learning objective. Assessment 815 from FIG. 8 is an example of the assessment/feedback data 430.

In a most extreme embodiment, which does not apply to all embodiments, the assessment/feedback data 430 may be provided well after the task is performed, yet the data can still be uploaded into the portfolio 405. The term “immediately,” as used herein, is a term of relativity that means an action (e.g., providing feedback) occurs right away or sometime after (or perhaps even during) another action occurs (e.g., the instructee's performance of a task). Immediate feedback may occur simultaneously with the performance of the activity, or it may occur sometime (e.g., seconds, minutes, or perhaps even hours) after the activity is complete. Accordingly, in most situations, feedback will be provided concurrently with or soon after (e.g., perhaps a few minutes) an activity is complete, but in some rare circumstances, the feedback may be provided later (e.g., a few hours or perhaps even days). Assessment 815 in FIG. 8 may be included as a part of assessment/feedback data 430.

The learning management system can also distribute the assessment/feedback data 430 to each party who is involved in the learning process such as, for example, the instructee, the instructor, and the administrator. This distribution may be performed on a periodic basis or in real-time. Consequently, in some cases, the data can be distributed to at least three separate entities.

Therefore, for a single task or activity, three different entities may be notified or alerted (e.g., automatic alerts or notifications can be sent to the different parties in response to triggering actions such as completion of a task or submission of feedback). As an example, instructees may receive performance and assessment data so they can improve their results, instructors can get training data of what activities are effectively improving the instructees' skills and what activities are not as effective so they can further tailor, refine, or modify those activities, and the administrators may be able to receive all of the data.

In some cases, the administrators receive data regarding the overall operations of their facilities and the learning management system. For example, the administrators may view how many drills of a particular kind have been used across the entire platform, or which specific instructees are following which specific drills, or which resources/equipment (or slopes or trails) are being used or are considered preferred by the instructees and instructors. With reference to the snow sporting example, some additional information that an administrator may receive is the pitch and snow quality currently on the mountain as well as the educational quality analytics discussed earlier. All of these different pieces of data can be brought together by the learning management system.

Similar to the assessment/feedback data 430, notes 435 may be included as a part of portfolio 405. Notes 435 may include any recorded thoughts, critique, or additional feedback that the instructor or learning management system may provide. In some cases, notes 435 may also include comments or thoughts provided by the instructee as well.

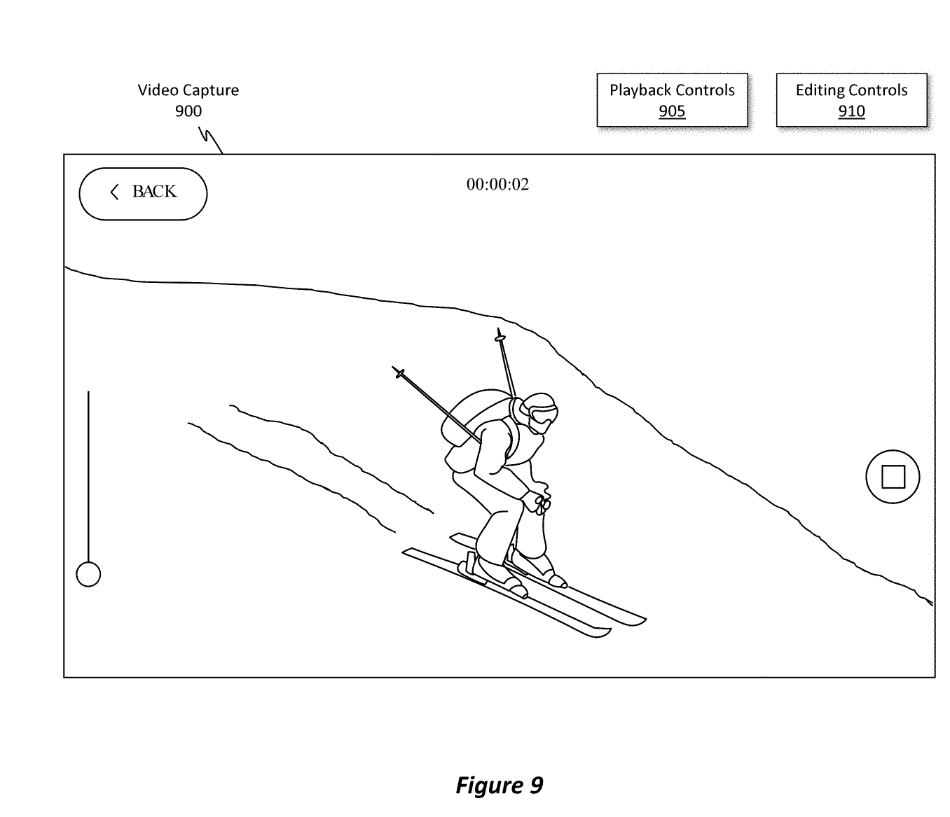

Portfolio 405 may also include any number of videos 440, images, or audio clips documenting the instructee's instant performance or documenting post or pre-activity thoughts or comments. FIG. 9 provides an example of a video clip that may be used.

Specifically, FIG. 9 illustrates a video capture 900 in the snow sporting industry. Here, video capture 900 is documenting the performance of an activity/task/criteria by an instructee. In some cases, the learning management system may include any number of playback controls 905, such as a play, pause, fast forward, reverse, and so on. Additionally, in some cases, the learning management system allows instructees and/or instructors to edit the video capture 900 via use of editing controls 910. These editing controls 910 enable users (e.g., the instructees and instructors) to directly annotate or otherwise edit the video capture 900.

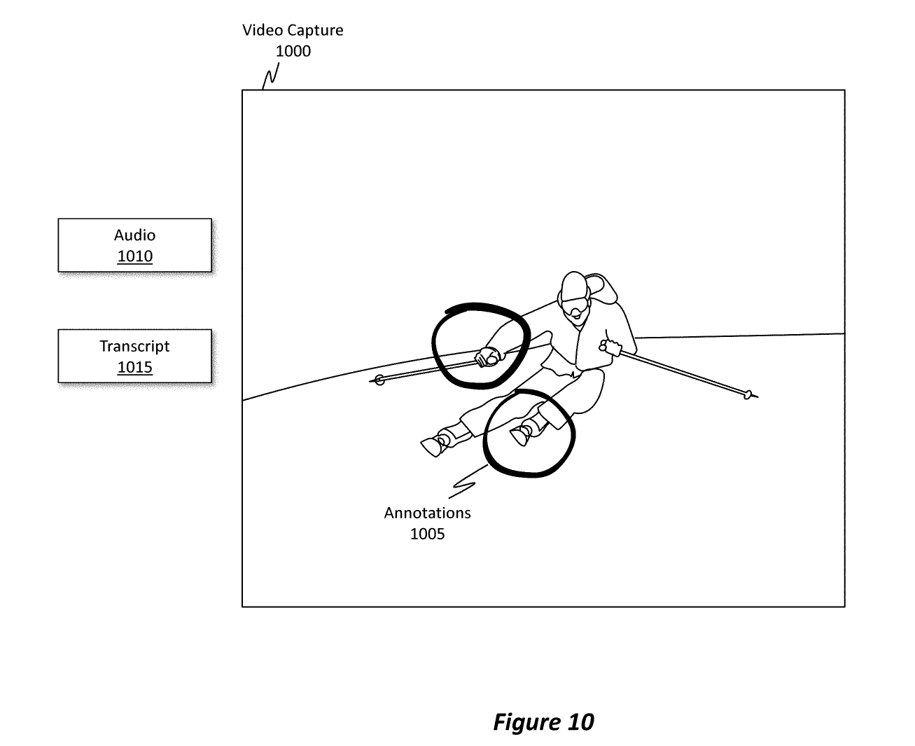

For example, FIG. 10 illustrates another video capture 1000, similar to video capture 900 of FIG. 9. Here, it is being shown how a user is able to provide one or more annotations 1005 directly to the video capture 1000 (e.g., by selecting the editing controls 910 from FIG. 9). In this particular context, the instructor has circled the instructee's feet position. It will be appreciated that any type of annotation may be performed on the video capture 1000. Example annotation types include, but are not limited to, highlights, drawings, text, and so on.

In some cases, an oral recording of the instructor's simultaneous or subsequent feedback can be overlaid on the video recording. For instance, while the instructor is reviewing or capturing the video capture 1000, the instructor can simultaneously speak into a microphone to orally provide feedback. This oral recording can then be attached to the video capture 1000. Therefore, when the instructee reviews the video capture 1000, the instructee can watch the video and simultaneously listen to the instructor's feedback.

As an example, in FIG. 10, the instructor can record him/herself saying that the instructee's balance appears to be slightly off in that the instructee is leaning too far backward. The learning management system can then automatically attach the oral feedback to the video (e.g., audio 1010 can be attached to video capture 1000). As the ski instructee is riding the lift back up the mountain, the ski instructee can watch the video capture 1000 and simultaneously listen to the instructor's feedback. The ski instructee can then try to apply the instructor's teachings in the next ski run. Accordingly, any type of annotation, be it a visual or oral annotation, can be affixed to the video capture 1000. In some embodiments, the learning management system generates a transcript (e.g., transcript 1015) of the instructor's audio feedback. This transcript may also be attached to the video capture 1000 and may also be played while the video capture 1000 is played. Therefore, the video capture 1000 can be displayed, the oral feedback can be played, and the transcript can be displayed all simultaneously with one another via a mobile device and corresponding user interface.

Returning to FIG. 4, the portfolio 405 is able to store and retain annotations 445 that the instructor or instructee provide to a video or image clip. Any annotations may be maintained by portfolio 405.

Portfolio 405 is also shown as including a progression path 450. This progression path 450 includes modifications to the instructee's training plan 420 based on the instructee's past performance, as generally described earlier in connection with modification 230 of FIG. 2. Here, the learning management system is able to automatically analyze the instructee's performance data 425 as well as the assessment/feedback data 430 in order to make one or more modifications to the instructee's training plan 420. These modifications may more fully emphasize a particular task or activity, or the modifications may cause the instructee to repeat a certain activity. In some cases, if it is determined that the instructee has adequate skill, then the modifications may cause certain tasks to be skipped so as to advance the instructee's progression.

It should be noted that the disclosed learning management systems can automatically provide the progression path 450. In some cases, however, the learning management system includes tools or features to enable the instructor to provide the progression path 450 or even to modify a progression path that was automatically derived by the learning management system. As such, the disclosed embodiments are highly flexible and allow for increased customization and personalization.

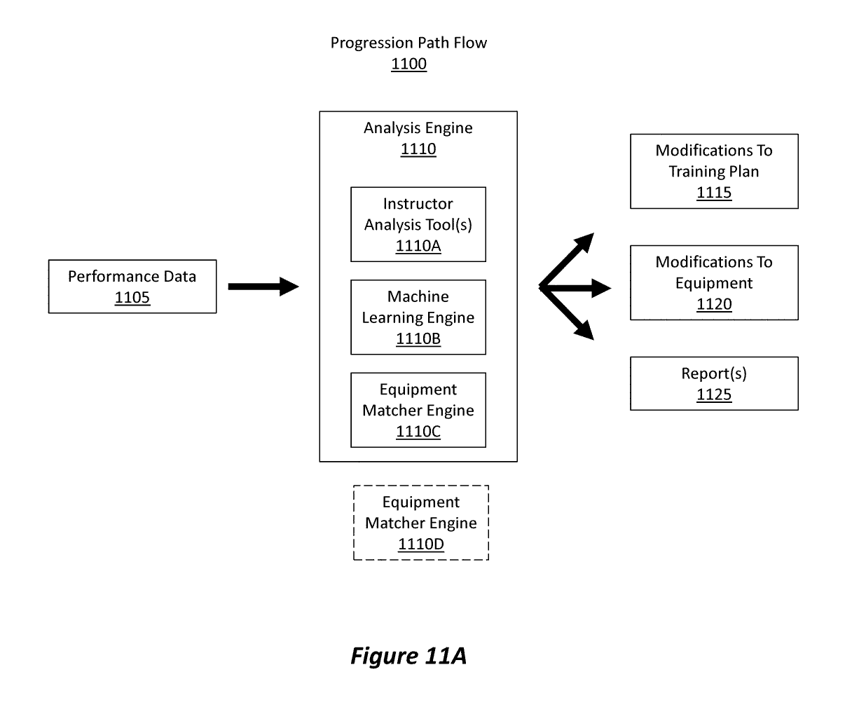

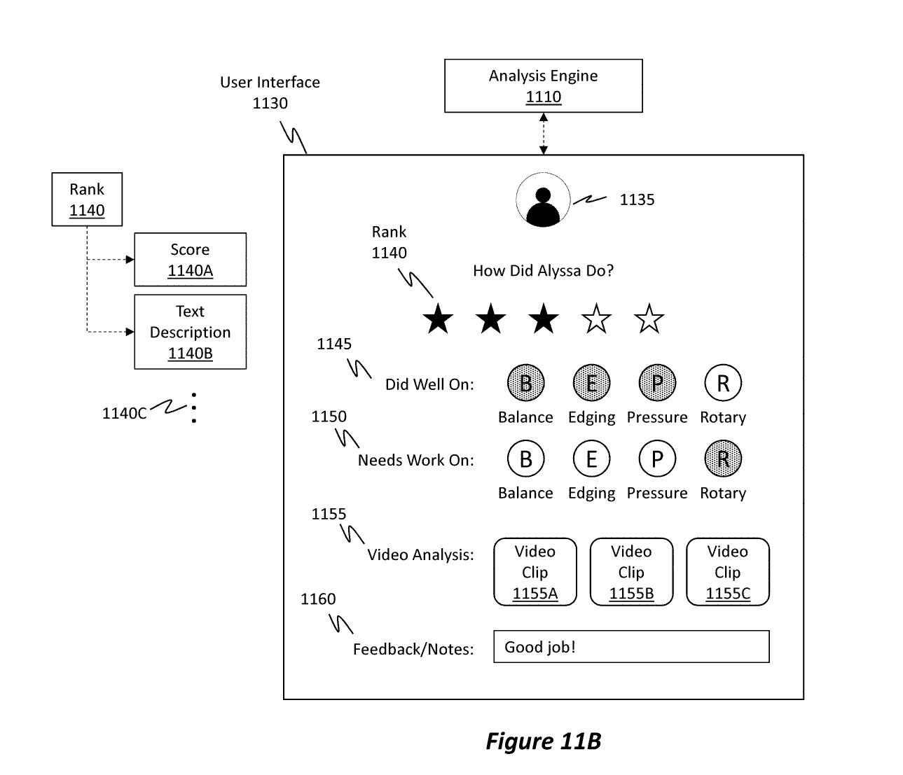

FIG. 11A shows an example of a progression path flow 1100 (i.e. a flow that may be followed to generate a post instruction performance summary and suggested next steps to follow) that may be followed in order to generate and/or modify the progression path 450 of FIG. 4. This progression path flow 1100 allows for instructor and instructee modification or generation of a progression path (e.g., a modification to the training plan) as well as for automatic generation of the progression path. It will be appreciated that an initial progression path may be generated for an instructee, wherein the initial progression path can be generated using the data from the initial analysis 205 in FIG. 2. As the instructee performance his/her tasks, the progression path can be modified, altered, or amended in accordance with the progression path flow 1100.

Initially, progression path flow 1100 is shown as collecting, obtaining, or accessing performance data 1105. This performance data 1105 may be obtained in the manner described earlier in connection with FIG. 8 (e.g., video data, audio data, timing data, position data, equipment data, and so on).

The performance data 1105 is fed into an analysis engine 1110. As used herein, analysis engine 1110 may be an application provided by a computer system. Specific details on “engines,” “modules,” and “components” will be provided later. In any event, analysis engine 1110 is a part of the disclosed learning management system and is executable by a computer system.

Analysis engine 1110 is shown as including one or more instructor (or instructee) analysis tool(s) 1110A, a machine learning engine 1110B, and an equipment matcher engine 1110C. In some cases, however, the equipment matcher engine 1110D may be a separate entity removed from the analysis engine 1110.

Instructor analysis tool(s) 1110A may include any tools that may assist an instructor in analyzing an instructee's performance data. For instance, the annotation and audio features discussed earlier may be included as a part of the instructor analysis tool(s) 1110A. In some cases, the instructor analysis tool(s) 1110A may include data analytics that can plot trends or trajectories in a set of data. These tools may also include clustering algorithms or other types of analytics to identify patterns or behaviors an instructee is portraying. The instructor is able to use these tools to analyze the instructee's performance data 1105 and provide critique or feedback. In this regard, the instructor may be heavily involved in providing a progression path in order to modify the instructee's training plan.

In other situations, the analysis engine 1110 may include a machine learning engine 1110B which is capable of independently and automatically analyzing the performance data 1105. Machine learning engine 1110B may include any type of machine learning algorithm or device, multilayer neural network, recursive neural network, deep neural network, decision tree model (e.g., decision trees, random forests, or gradient boosted trees), linear regression model, logistic regression model, support vector machine (“SVM”), artificial intelligence device, or any other type of intelligent computer system. Using the machine learning engine 1110B, the analysis engine 1110 can analyze the performance data 1105 to identify patterns, trends, behaviors, deficiencies, or proficiencies in the instructee's performance of an activity. As an example, the machine learning engine 1110B can analyze the video capture 1000 in FIG. 10 to also identify the instructee's balance issue. In this regard, an assessment of the instructee's performance data may be performed by applying machine learning to the performance data to learn of any training or skill problems the instructee may have.

Once an analysis is performed, the analysis engine 1110 is able to generate one or more modifications to the training plan 1115, one or more modifications to equipment 1120, and even one or more reports 1125. The modifications to the training plan 1115 may cause the instructee's training plan to be altered in any of the manners discussed earlier. Similarly, the reports 1125 may outline or detail how the instructee performed and how the instructee can improve.

Turning briefly to FIG. 11B, this figure illustrates one example of some of the output that the analysis engine 1110 may generate and visually display within a user interface 1130. It will be appreciated that the contents rendered within user interface 1130 are being provided for example purposes only.

User interface 1130 is shown as including an avatar 1135 of the instructee. Avatar 1135 may be an actual picture of the instructee, or it may be another type of selected image used to represent the instructee.

User interface 1130 is also shown as including a rank 1140 metric for the instructee. In some cases, the rank 1140 may be visually illustrated in the form of a number of stars (e.g. 5 stars), where the different formatting of the stars symbolically represents how well the instructee performed. For instance, three of the five stars have a boldened appearance while the remaining two are not bolded. Because only three stars are boldened, the instructee performed in a relatively average manner. More stars indicate advanced proficiency while fewer stars indicate lower proficiency. As such, different formats for rank 1140 may be used to visually illustrate how well the instructee performed.

Other ranking techniques may be used as well, however. For instance, FIG. 11B shows that rank 1140 may additionally include a numeric score 1140A or even text descriptions 1140B. The ellipsis 1140C symbolically represents that other types of techniques may be used. The score 1140A may be implemented in the manner discussed earlier (e.g., a number within the different ranges, such as between 0 and 100). The text description 1140B may similarly be implemented in the manner discussed earlier (e.g., “Apprehensive,” “Measured,” “Relaxed,” and “Aggressive”). The instructor (or the analysis engine 1110) is able to provide an assessment regarding the instructee's performance and provide that assessment in the form of rank 1140, as well as other forms (e.g., feedback, critique, etc.).

The assessment may also indicate specific areas of performance where the instructee performed well, poorly, or average. For instance, good performance 1145 visually emphasizes the areas where the instructee performed very well. FIG. 11B shows good performance 1145 in which a ski instructee performed well on balance, edging, and pressure, as shown by the emphasized format of those areas of performance. On the other hand, needs improvement 1150 shows that the ski instructee should improve in the rotary skill, as visually illustrated by the difference in format of the “Rotary” option in user interface 1130.

User interface 1130 also includes a video analysis portion 1155 where video clips of the instructee's performance can be posted and made readily or immediately available for the instructee to select, view, and interact with. Specifically, the video analysis portion 1155 shows a first video clip 1155A, a second video clip 1155B, and a third video clip 1155C. While only three are illustrated, it will be appreciated that any number of video clips may be provided to the instructee. Furthermore, these video clips may be formatted, modified, or otherwise enhanced (e.g., via annotations) in any of the manners discussed earlier. Even further, the user interface is configured to simultaneously display any number of video clips that each record at least a portion of the instructee's performance of his/her trackable criteria/tasks/objectives.

User interface 1130 is also shown as including a feedback section 1160 in which the instructor can provide additional feedback (e.g., aside from the feedback provided within the video clips) to the instructee. Here, the feedback section 1160 shows that the instructor said “Good job!” to the instructee.

Accordingly, user interface 1130 is just one example of some of the content that analysis engine 1110 is able to provide to an instructee as well as to an instructor. User interface 1130 may be displayed in a mobile device, which may include a touch screen interface for selecting and interacting with the different visual objects included within user interface 1130. Of course, other information may also be visually displayed within user interface 1130. In some cases, this other information may be displayed simultaneously or concurrently with the information currently presented in FIG. 11B. In other cases, one or more tabs may be provided within user interface 1130 to allow for additional information to be presented without overpopulating a specific section of the user interface 1130.

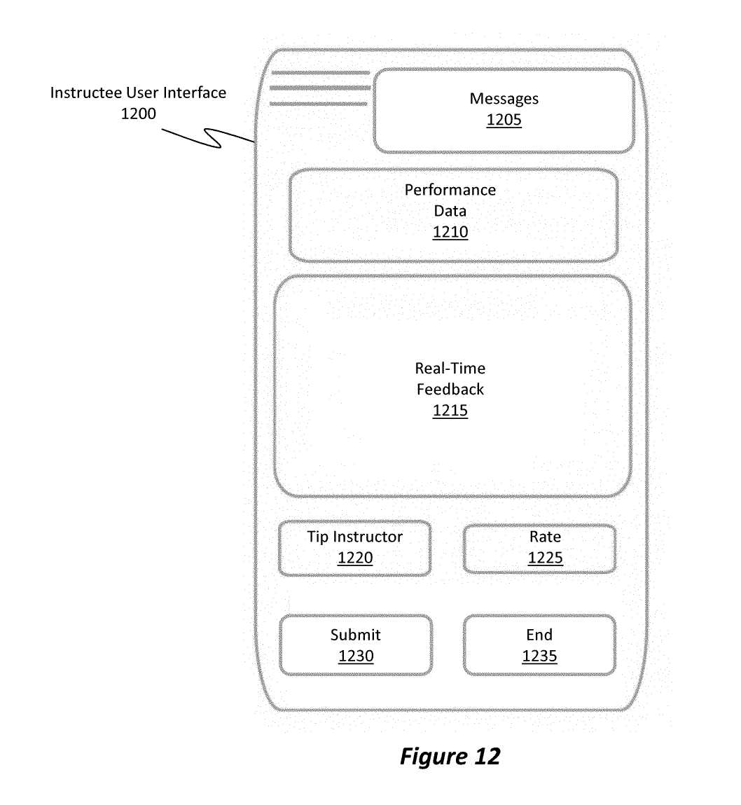

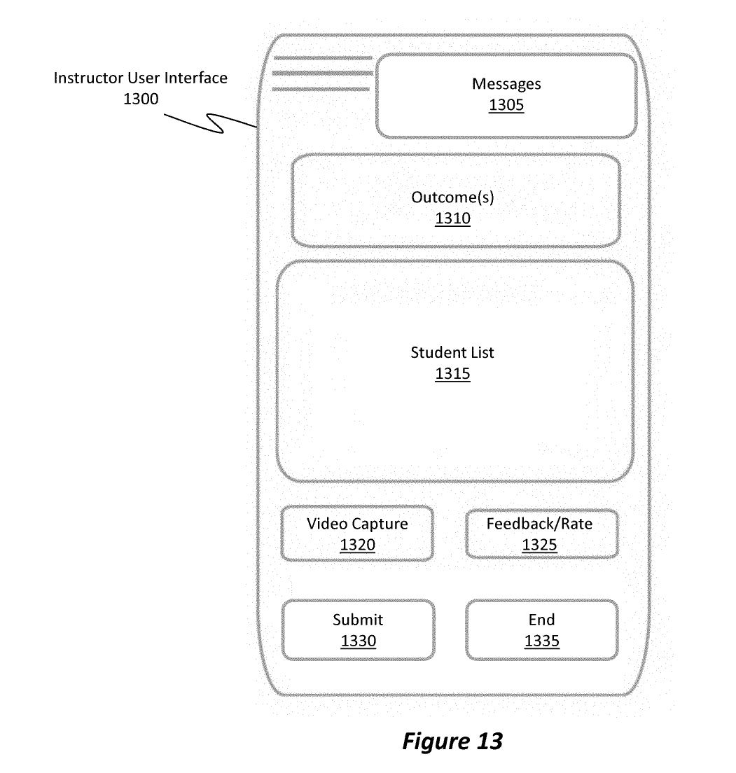

FIGS. 12 and 13 illustrate additional user interfaces that may be used. FIG. 12 shows an instructee user interface 1200 that includes a messages section 1205 (e.g., for receiving and responding to messages from the instructor, other students, and so on), a performance data section 1210 (e.g., the performance data discussed earlier), a real-time feedback section 1215 (e.g., to receive the feedback discussed earlier), a tip instructor section 1220 (e.g., to provide a monetary tip or other form of additional compensation to the instructor), a rate section 1225 (e.g., to rate the school or the instructor), a submit button 1230 (e.g., for submitting information), and an end session button 1235. The layout and format of instructee user interface 1200 may vary or be customized in any manner.

FIG. 13 shows a similar user interface as the one shown in FIG. 12, but this user interface is now for an instructor. Specifically, FIG. 13 shows an instructor user interface 1300 that includes a messages section 1305 (e.g., similar to the instructee messages section), an outcome(s) section 1310 (e.g., to view the performance data of an instructee), a student list section 1315 (e.g., to list all of the students the instructor has previously, is currently, or will be working with), a video capture option 1320 (e.g., to capture a video of the instructee's performance of a task), a feedback/rate option 1325 (e.g., to provide the ratings and feedback discussed earlier), a submit option 1330 (e.g., to submit feedback), and an end session option 1335 to end the training session (e.g., to clock in and clock out so as to monitor how long an instructor spends time with an instructee, perhaps for billing purposes). Similar to the earlier discussion, the format and layout of instructor user interface 1300 may vary and may be individually tailored to a user's preference.

### Equipment Matcher

Returning to FIG. 11A, the equipment matcher engines 1110C and 1110D may be used to identify and recommend specific pieces of equipment to an instructee. For example, in the ski example, a recommendation may be generated indicating that a certain pair of skis or boots or poles may help the instructee improve his/her form or skill.

As the learning management system creates a progression path and monitors the instructee's progress through that progression path, the equipment matcher engine can help the instructee select specific pieces of equipment so as to help facilitate the instructee's progress. This equipment matcher engine is able to review and analyze some or all of the instructee's performance data to assess the instructee's skill level. Based on the skill level, his/her identified techniques, and potentially even the next upcoming task activities, the equipment matcher engine can generate a recommendation to inform the instructee that certain pieces of equipment may help the instructee progress through his/her training plan (i.e. a progression path).

Previously, the process of selecting equipment was typically performed via a subjective suggestion from a coach or a sales representative. Previously, there was no objective technique to recommend equipment to an instructee. The disclosed embodiments are now able to provide this objective, fact-based equipment suggestion through the use of the equipment matcher engine. This engine can obtain actual empirical data (e.g., the performance data) and can obtain the analysis engine's assessment of the instructee's behaviors, trends, patterns, and skill level. Based on this information, the equipment matcher engine can recommend certain pieces of equipment to the user, thereby removing the subjective elements that were previously prevalent in the technology.

In some cases, the equipment matcher engine is able to query the Internet to identify equipment from different manufacturers. The equipment matcher engine can identify specific types of equipment that are designed to achieve specific end results based on the specifications provided for those pieces of equipment. In some cases, machine learning may be used to perform this identification and analysis.

Using the skiing example, the equipment matcher engine can query any number of snow sport manufacturers to identify their products and how those products should be used. If the instructee is determined to have balancing problems (e.g., by the analysis engine 1110), then the equipment matcher engine can automatically identify a type of ski or boot or pole that may be designed to help with the instructee's specific type of balancing problem. Accordingly, the equipment matcher engine is able to provide customized equipment matching recommendations to link an instructee to a particular type of equipment designed to help the instructee successfully accomplish the different task-based objectives.

In this regard, the disclosed learning management systems can provide recommendations not only for what the instructee should do during the next task, but also a recommendation for which equipment the instructee should use, based on the detected attributes of the instructee. In the snow sporting industry, there is a large variety of equipment designed to help instructees improve their techniques. The number of different options is almost unmanageable without assistance. The disclosed embodiments are able to beneficially match instructees to equipment based on the data provided within their profiles.

The disclosed embodiments are able to acquire and aggregate information, learn (e.g., perhaps through machine learning) the skill level of an instructee, and then (based on the level) match the instructee to tailored equipment. Other recommendations can also be provided, such as, for example, additional instruction products (e.g., additional ski products). With reference to the skiing example, one or more performance camps may be recommended. Accordingly, any type of equipment, resource, or training material may be included in the recommendation and may be provided in a standardized, objective manner based on actual performance data.

Returning to FIG. 4, portfolio 405 can also include lesson history 455, which records and documents one, some, or all of the instructee's previous lessons. These lessons can be made available to the instructee on demand. In this regard, a digital portfolio (e.g., portfolio 405) may include a lesson history that includes history data describing previous lessons the instructee has performed. Finally, portfolio 405 can include any number of reports 460 documenting how the instructee performed as well as documenting any feedback or critique provided from the instructor. The ellipsis 465 illustrates how other information may additionally be included in portfolio 405.

### Additional Techniques for Capturing Performance Data and Displaying Feedback

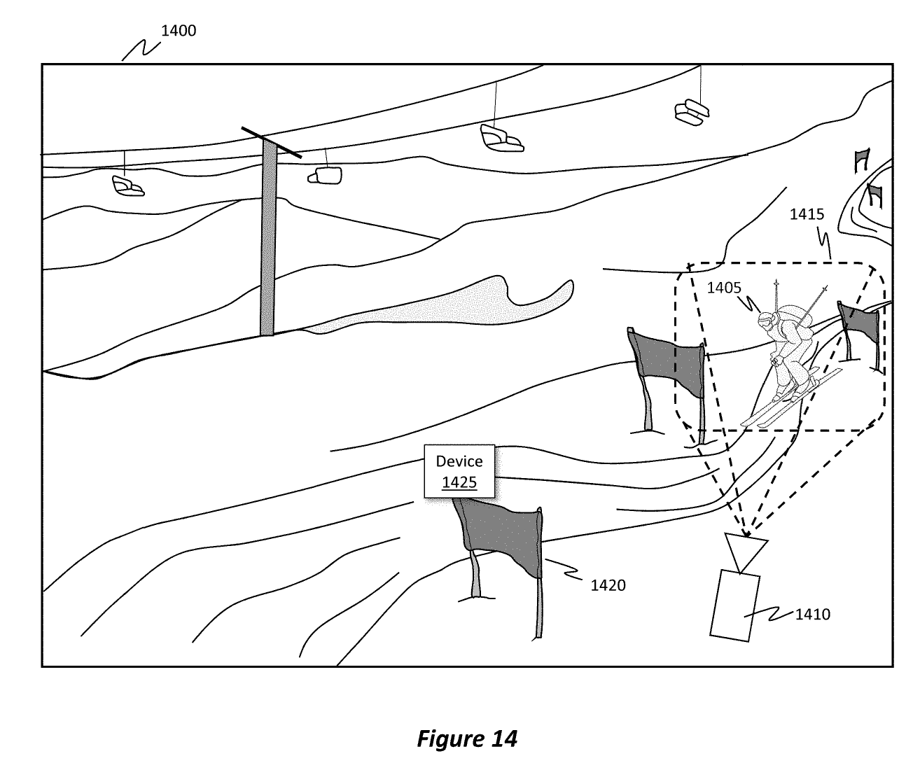

FIG. 14 illustrates one example technique for capturing performance data using a camera disposed within a learning environment. It will be appreciated that the camera may be disposed at a location within the environment or the camera may be disposed on the instructee's own person (e.g., a wearable camera unit). In some cases, an instructor can hold the camera while in other cases a cameraman can be positioned on the slop and can record the video.

Specifically, FIG. 14 illustrates a mountain environment 1400 that includes a skier 1405 (e.g., an instructee) skiing down a mountain. Here, a camera 1410 is being used to capture still images and/or videos of the skier 1405 as he/she makes the run down the mountain. The videos may be of any duration. Typical durations are between 20 to 30 seconds, however. As shown, the camera 1410's field of view (FOV) 1415 captures the skier 1405. The recorded data can then be automatically tagged as belonging to skier 1405, uploaded to skier 1405's corresponding portfolio, and then analyzed to determine the skill level of the skier 1405 and to identify areas of improvement.

It will be appreciated that camera 1410 can be placed at any location within the mountain environment 1400. In some cases, the instructor may be holding the camera 1410 and tracking the skier 1405 as the skier 1405 progresses down the mountain. In other cases, the camera 1410 may be mounted at a location within the mountain environment 1400 or even mounted on the skier 1405. In some cases, the camera 1410 may be mounted on a gate 1420 situated in the mountain environment 1400. In some cases, multiple cameras may be used to provide a sort-of panoramic recording of the skier 1405.

For instance, as the skier 1405 enters the FOV of one camera, which may have a link with the learning management system, that camera can be triggered to begin to capture a video of the skier 1405 (e.g., the camera can be triggered based on movement using a motion detector/sensor). Once the skier 1405 leaves the camera's FOV, that camera can stop recording and another camera can be used to record the skier 1405, where the other camera is positioned to now record the skier 1405's movement (e.g., a line of cameras may be positioned along the entire length of the ski slope).

These different video recordings can then be combined or otherwise stitched together by the learning management system to create a new consolidated/aggregated video recording of the skier 1405's entire progress down the mountain. A user interface may be configured to display the aggregate video clip, which is an aggregation of a plurality of video clips recording the instructee's performance of certain trackable criteria/tasks/objectives. In some cases, a camera, which recorded at least one video clip included in the plurality of video clips, was triggered to begin recording in response to a detected movement of the instructee (e.g., a ski student entered the camera's field of view while skiing down the mountain, thereby triggering the camera to begin recording based on movement detection).

Other devices may be used to collect performance data as well. These other devices can be mounted at any location within the learning environment (e.g., mountain environment 1400). In FIG. 14, device 1425 is mounted on the gate 1420. Additionally, devices on the gates can be used to help plan a course on the slope via digital means (e.g., a course planning application implemented in software) and can even help determine the current snow conditions on the mountain.

Device 1425 may include any type of device for monitoring the performance of an instructee. Example types of devices include, but are not limited to, IMUs, GPS, head tracking cameras, cell phones, and so on. In some cases, device 1425 includes weather tracking features to determine the current weather and snow conditions on the mountain.

In some cases, an instructee can even wear a wearable device to monitor his/her kinesthetic movements. These wearable devices can be in the form of a head-mounted device (HMD), a watch, a RFID unit stitched in a bib, or any other device capable of being disposed on the instructee's person. In some cases, the learning management system is configured to communicate with a wearable device being worn by the instructee, where the wearable device is configured to collect data that may then be included in the instructee's performance data. Accordingly, the disclosed embodiments are operable with any kind of wearable device or even any kind of Internet Of Things (IoT) device.

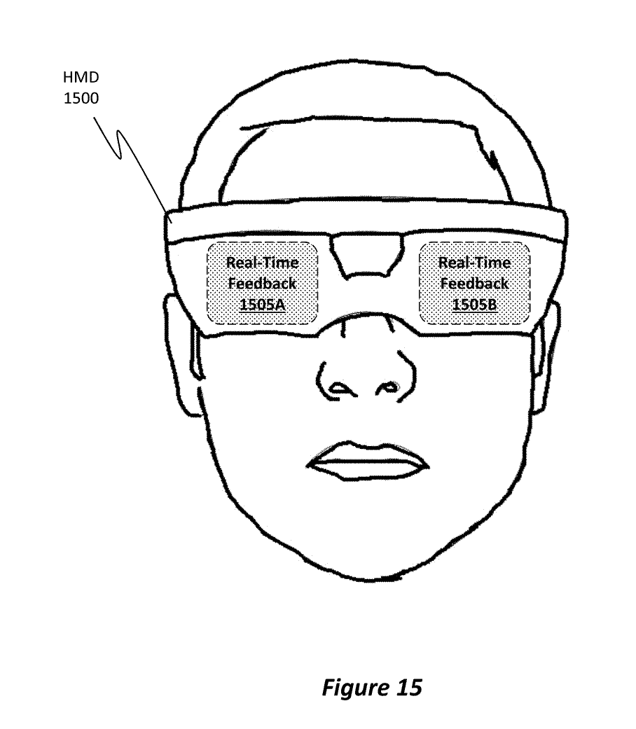

FIG. 15 shows one example of an HMD 1500, which a user may wear. In some cases, HMD 1500 can have a form factor of glasses or of snow sport goggles. HMD 1500 may be an augmented-reality device that is capable of projecting virtual images into the real world. Examples of these virtual images include video clips, text, holograms of the instructor, or any other type of feedback. In some cases, HMD 1500 can even provide instructions or guidance as the instructee performs a run down the mountain (e.g., real-time assistive guidance provided during the performance of a task). The learning management system may be implemented by HMD 1500.

FIG. 15 shows how HMD 1500 is able to render real-time feedback 1505A and 1505B for the user to view. Such a feature is particularly beneficial because it enables the instructee to learn of the feedback without requiring the instructee to remove any gloves or other equipment. As an example, the instructee can be riding the ski lift back up the mountain and view or learn of the instructor's feedback without having to remove any gloves, clothing, or equipment. Furthermore, when HMD 1500 is used, the instructee need not remove a portable device from his/her pocket to view the feedback. In other cases, the learning management system may be implemented on a phone, tablet, or other type of portable device, and the instructee can view the instructor's feedback from these portable devices. Accordingly, real-time feedback 1505A and 1505B may be provided to an instructee through use of an HMD 1500.

### Example Method(s) for Implementing a Learning Management System

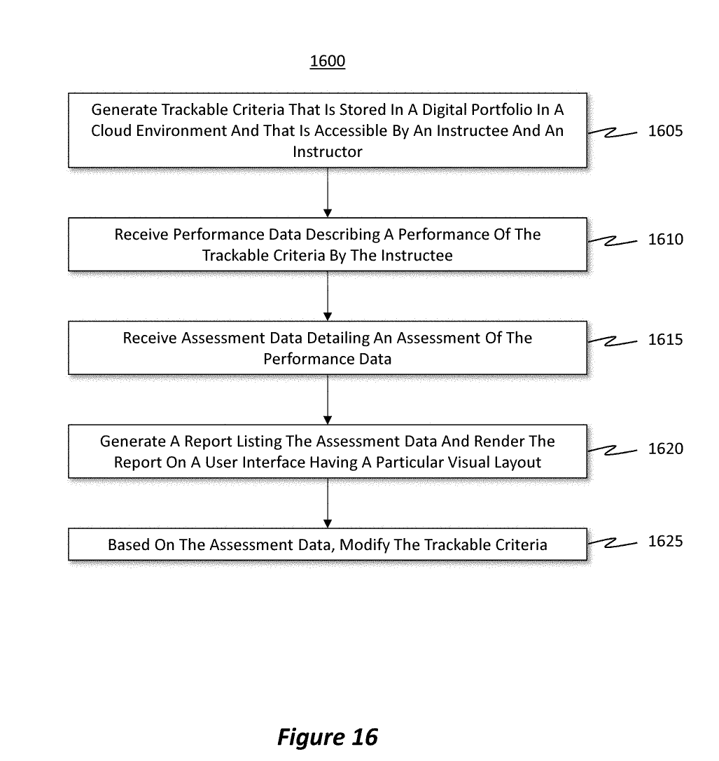

Attention will now be directed to FIG. 16 which refers to a number of method acts that may be performed. Although the method acts may be discussed in a certain order or illustrated in a flow chart as occurring in a particular order, no particular ordering is required unless specifically stated, or required because an act is dependent on another act being completed prior to the act being performed.

FIG. 16 illustrates a flowchart of an example method 1600 for generating, monitoring, and analyzing/assessing task-based learning objectives via a learning management system, such as the ones discussed previously. Initially, method 1600 includes an act 1605 of generating a set of one or more trackable criteria/tasks/activities for an instructee. The trackable criteria can be any of the previously described drills, tasks, or activities included within the training plan discussed earlier. Here, the set of trackable criteria is stored in a digital portfolio (e.g., portfolio 310 from FIG. 3A) in a cloud environment (e.g., cloud 305). This digital portfolio is accessible by at least the instructee and an instructor of the instructee. It can also be accessed by an administrator.

Method 1600 also includes an act 1610 of receiving or accessing performance data describing a performance of the set of one or more trackable criteria by the instructee, as described earlier. Method 1600 also includes an act 1615 of receiving or accessing assessment data (e.g., assessment/feedback data 430 from FIG. 4) detailing an assessment of the performance data. This assessment data describes how closely the performance of the set of one or more trackable criteria corresponds with a desired performance (or a desired proficiency threshold) defined by the set of one or more trackable criteria/tasks.

For instance, the assessment can indicate whether a ski student successfully completed a particular drill or whether the ski student needs additional work on that drill. The assessment may be performed by the instructor and/or the learning management system (e.g., via machine learning).

The criteria/tasks can indicate that it is desirable for the instructee to achieve a certain level of proficiency (e.g., the desired performance) before the instructee is permitted to continue on to the next criteria/task/objective. In some cases, the assessment data includes an overall ranking of the performance (e.g., rank 1140 from FIG. 11B). In some implementations, the assessment data includes video annotations displayed on the video clip. The assessment data may also include an oral or audio recording recorded by the instructor, where the oral recording provides feedback regarding the instructee's performance. This oral/audio recording can be attached to the video clip such that, when the video clip is played, the oral recording is simultaneously played. A transcript may also be provided, as described earlier.

Method 1600 also includes an act 1620 of generating a report listing the assessment data and of rendering the report on a user interface of a computer system (e.g., a mobile device). The user interface's layout is configured to display at least some of the assessment data simultaneously with at least some of the performance data (e.g., FIG. 11B shows rank 1140 as well as a first video clip 1155A). The displayed assessment data also includes the overall ranking.

Based on the assessment data, method 1600 then includes act 1625 of modifying the set of one or more trackable criteria. This modification may be performance by the analysis engine 1110 of FIG. 11A to produce the modifications to the training plan 1115.

In some cases, method 1600 may include additional steps. For instance, the method may further include an act of determining a skill level of the instructee, determining current equipment the instructee currently has, and then determining a next set of trackable criteria the instructee is to perform (e.g., the progression path discussed earlier).

Based on (i) the skill level, (ii) the current equipment, and (iii) the next set of trackable criteria, the method may cause a recommendation to be generated, where the recommendation lists a set of recommended equipment for the instructee. This set of recommended equipment may be equipment selected to facilitate the instructee's performance of the next set of trackable criteria.

Accordingly, the disclosed embodiments relate to an improved type of learning management system that may be used across all different types of learning environments. For instance, many ski schools still base their learning techniques on an antiquated apprenticeship learning model. If a student gets a ski lesson, the student meets with an instructor who is a subject matter expert. The instructor sees what the student does and suggests drills for the student to perform on the mountain. The instructor then gives the student audio or oral feedback telling the student how to improve. At the end of the day, however, the student walks away with no tangible or viewable information.

The disclosed learning management systems solve the above problems by capturing performance data and instructional data and delivering it to the student. Therefore, at the end of the day, the student has actual data that can be reviewed. The student is provided with a performance report detailing who the student trained with, where the student trained, how long the student trained, what drills the student performed, where the student performed those drills, and a video documenting those drills and instruction. The student is provided with instructional feedback such as a movement analysis that includes balance, edging, pressure, and control critiques.

Additionally, the disclosed learning management systems allow for standardization or unification in how students are trained by instructors because the learning management system provides a robust platform which instructors can use and consult. As such, this learning management system will improve the overall quality of training that is being provided by instructors and will help students advance at a faster rate.

### Example Computer System(s)

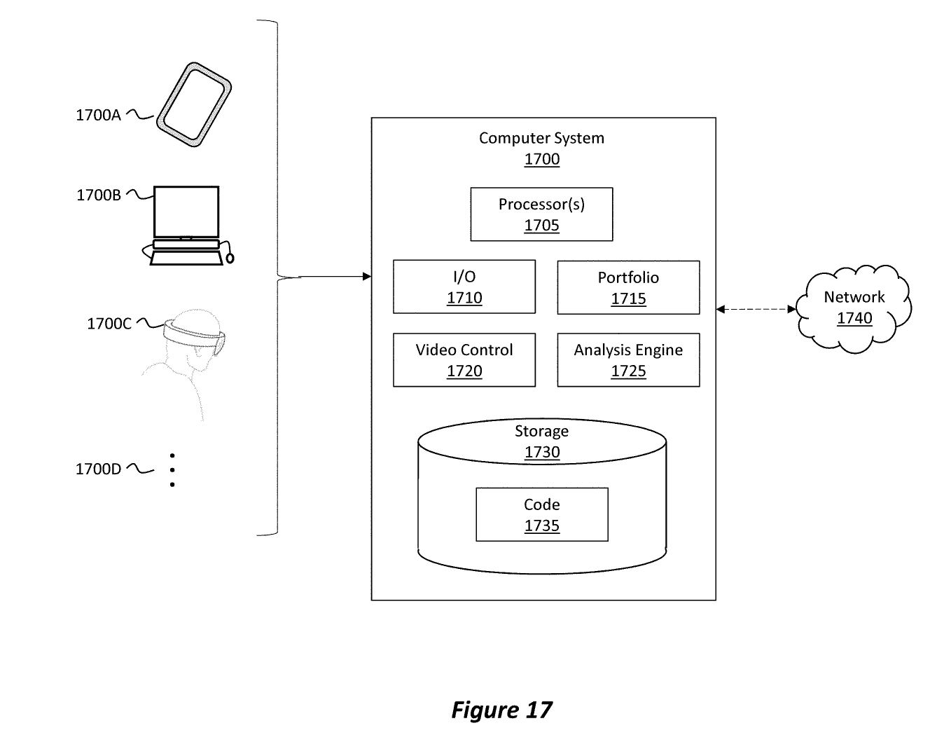

Attention will now be directed to FIG. 17 which illustrates an example computer system 1700 that may be used to facilitate the disclosed learning management systems and methods and/or that may comprise one of the disclosed systems, architectures, or learning management systems. It will be appreciated that computer system 1700 may be configured within various form factors. For example, computer system 1700 may be embodied as a tablet 1700A, a desktop 1700B, or a head mounted device (HMD) 1700C. The ellipsis 1700D demonstrates that computer system 1700 may be embodied in various other forms too.

For instance, computer system 1700 may also be a distributed system that includes one or more connected computing components/devices that are in communication with computer system 1700, a laptop computer, a mobile phone, a server, a data center, and/or any other computer system. The ellipsis 1700D also indicates that other system subcomponents may be included or attached with the computer system 1700, including, for example, sensors that are configured to detect sensor data such as user attributes (e.g., heart rate sensors), as well as sensors like cameras and other sensors that are configured to detect sensor data such as environmental conditions and location/positioning (e.g., clocks, pressure sensors, temperature sensors, gyroscopes, accelerometers, and so forth), all of which sensor data may comprise different types of information used during application of the disclosed embodiments.

In its most basic configuration, computer system 1700 includes various different components. For example, FIG. 17 shows that computer system 1700 includes at least one processor 1705 (aka a “hardware processing unit”), input/output (“I/O”) 1710, a portfolio 1715, a video control 1720, an analysis engine 1725, and storage 1730. Collectively, the portfolio 1715, the video control 1720, and the analysis engine 1725 (which may include the equipment matcher engine) may be included as parts of the disclosed learning management system.

Storage 1730 is shown as including executable instructions/code 1735. Storage 1730 may be physical system memory, which may be volatile, non-volatile, or some combination of the two. The term “memory” may also be used herein to refer to non-volatile mass storage such as physical storage media. If computer system 1700 is distributed, the processing, memory, and/or storage capability may be distributed as well. As used herein, the term “executable module,” “executable component,” “engine,” “module,” or even “component” can refer to software objects, routines, or methods that may be executed on computer system 1700. The different components, modules, engines, and services described herein may be implemented as objects or processors that execute on computer system 1700 (e.g. as separate threads).

The disclosed embodiments may comprise or utilize a special-purpose or general-purpose computer including computer hardware, such as, for example, one or more processors (such as processor 1705) and system memory (such as storage 1730), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are physical computer storage media. Computer-readable media that carry computer-executable instructions are transmission media. Thus, by way of example and not limitation, the current embodiments can comprise at least two distinctly different kinds of computer-readable media: computer storage media and transmission media.

Computer storage media are hardware storage devices, such as RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1700 may also be connected (via a wired or wireless connection) to external sensors (e.g., one or more remote cameras, accelerometers, gyroscopes, acoustic sensors, magnetometers, GPS, etc.). Further, computer system 1700 may also be connected through one or more wired or wireless networks 1740 to remote systems(s) that are configured to perform any of the processing described with regard to computer system 1700 and that may be connected to the cloud (e.g., cloud 305 from FIG. 3A).

During use, a user (e.g., an instructee or instructor) of computer system 1700 is able to perceive information through a display screen that is included with the I/O 1710 of computer system 1700 and that is visible to the user. The I/O interface(s) and sensors with the I/O 1710 also include other movement detecting components (e.g., cameras, gyroscopes, accelerometers, magnetometers, acoustic sensors, global positioning systems (“GPS”), etc.) that are able to detect positioning and movement of users to collect performance data.

The portfolio 1715 is representative of the portfolios discussed earlier. Similarly, the video control 1720 may include camera devices and/or applications used to edit or annotate videos or images. The analysis engine 1725 is also representative of the analysis engines discussed earlier.

A “network,” like the network 1740 shown in FIG. 17, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1700 will include one or more communication channels that are used to communicate with the network 1740. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions (e.g., code 1735) comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

Additionally, or alternatively, the functionality described herein can be performed, at least in part, by one or more hardware logic components (e.g., the processor 1705). For example, and without limitation, illustrative types of hardware logic components that can be used include Field-Programmable Gate Arrays (FPGAs), Program-Specific or Application-Specific Integrated Circuits (ASICs), Program-Specific Standard Products (ASSPs), System-On-A-Chip Systems (SOCs), Complex Programmable Logic Devices (CPLDs), Central Processing Units (CPUs), and other types of programmable hardware.

It will be appreciated that computer system 1700 may include one or more processors (e.g., processor(s) 1705) and one or more computer-readable hardware storage devices (e.g., storage 1730), where the storage devices include computer-executable instructions (e.g., code 1735) that are executable by the one or more processors to perform any method (e.g., method 1600 presented in FIG. 16). In this regard, computer system 1700 is also highly flexible and can perform numerous operations.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processor(s); and
one or more computer-readable hardware storage device(s) having stored thereon computer-executable instructions that are executable by the one or more processor(s) to cause the computer system to monitor task-based learning objectives via a learning management system by causing the computer system to:
generate a set of one or more trackable criteria for an instructee, the set of trackable criteria being stored in a digital portfolio in a cloud environment, the digital portfolio being accessible by at least the instructee and an instructor of the instructee;
receive performance data describing a performance of the set of one or more trackable criteria by the instructee;
receive assessment data detailing an assessment of the performance data, wherein the assessment data describes how closely the performance of the set of one or more trackable criteria corresponds with a desired performance defined by the set of one or more trackable criteria, and wherein the assessment data includes an overall ranking of the performance;
generate a report listing the assessment data and render the report on a user interface of the computer system, wherein a layout of the user interface is configured to display at least some of the assessment data simultaneously with at least some of the performance data, the displayed at least some of the assessment data including the overall ranking; and
based on the assessment data, modify the set of one or more trackable criteria.

2. The computer system of claim 1, wherein the learning management system includes an instructee portal, an instructor portal, and an administrator portal for accessing the digital portfolio.

3. The computer system of claim 1, wherein the digital portfolio includes profile data for the instructee and the instructor.

4. The computer system of claim 3, wherein the profile data includes one or more of the following: body metrics of the instructee, equipment currently used by the instructee, a number of years of experience of the instructor, an area of expertise of the instructor, an instructor history, instructor professional training data, or student performance data.

5. The computer system of claim 1, wherein the digital portfolio includes a lesson history that includes history data describing previous lessons the instructee has performed.

6. The computer system of claim 1, wherein the user interface displays one or more plots that graph the performance data.

7. The computer system of claim 1, wherein the user interface displays one or more learning areas and a corresponding score for each one of said one or more learning areas.

8. The computer system of claim 1, wherein the performance data includes a video clip capturing the instructee while the instructee was performing at least one of the one or more trackable criteria included in the set of one or more trackable criteria.

9. The computer system of claim 8, wherein:
the assessment data includes video annotations displayed on the video clip,
the assessment data includes an oral recording recorded by the instructor, the oral recording describing feedback regarding the performance, and
the oral recording is attached to the video clip such that, when the video clip is played, the oral recording is simultaneously played.

10. The computer system of claim 1, wherein execution of the computer-executable instructions further causes the computer system to:
determine a skill level of the instructee;
determine current equipment the instructee currently has;
determine a next set of trackable criteria the instructee is to perform; and
based on (i) the skill level, (ii) the current equipment, and (iii) the next set of trackable criteria, generate a recommendation listing a set of recommended equipment for the instructee, the set of recommended equipment being equipment selected to facilitate performance of the next set of trackable criteria.

11. A method for monitoring task-based learning objectives via a learning management system that is implemented by a computer system, the method comprising:
generating a set of one or more trackable criteria for an instructee, the set of trackable criteria being stored in a digital portfolio in a cloud environment, the digital portfolio being accessible by at least the instructee and an instructor of the instructee;
receiving performance data describing a performance of the set of one or more trackable criteria by the instructee;
receiving assessment data detailing an assessment of the performance data, wherein the assessment data describes how closely the performance of the set of one or more trackable criteria corresponds with a desired performance defined by the set of one or more trackable criteria, and wherein the assessment data includes an overall ranking of the performance;
generating a report listing the assessment data and render the report on a user interface of the computer system, wherein a layout of the user interface is configured to display at least some of the assessment data simultaneously with at least some of the performance data, the displayed at least some of the assessment data including the overall ranking; and
based on the assessment data, modifying the set of one or more trackable criteria.

12. The method of claim 11, wherein the method further includes the computer system performing at least the following:
determining a skill level of the instructee;
determining current equipment the instructee currently has;
determining a next set of trackable criteria the instructee is to perform; and
based on (i) the skill level, (ii) the current equipment, and (iii) the next set of trackable criteria, generating a recommendation listing a set of recommended equipment for the instructee, the set of recommended equipment being equipment selected to facilitate performance of the next set of trackable criteria.

13. The method of claim 11, wherein the learning management system communicates with a wearable device being worn by the instructee, the wearable device collecting data that is included in the performance data.

14. The method of claim 11, wherein the computer system is a head-mounted device, and wherein the assessment of the performance data includes machine learning being applied to the performance data.

15. The method of claim 11, wherein the user interface simultaneously displays a plurality of video clips that each record at least a portion of the performance of the set of one or more trackable criteria.

16. The method of claim 11, wherein the user interface displays an aggregate video clip that is an aggregation of a plurality of video clips recording the performance of the set of one or more trackable criteria, and wherein a camera that recorded at least one video clip included in the plurality of video clips was triggered to begin recording the at least one video clip in response to a detected movement of the instructee.

17. One or more hardware storage device(s) having stored thereon computer-executable instructions that are executable by one or more processor(s) of a computer system to cause the computer system to monitor task-based learning objectives via a learning management system by causing the computer system to:
generate a set of one or more trackable criteria for an instructee, the set of trackable criteria being stored in a digital portfolio in a cloud environment, the digital portfolio being accessible by at least the instructee and an instructor of the instructee;
receive performance data describing a performance of the set of one or more trackable criteria by the instructee;
receive assessment data detailing an assessment of the performance data, wherein the assessment data describes how closely the performance of the set of one or more trackable criteria corresponds with a desired performance defined by the set of one or more trackable criteria, and wherein the assessment data includes an overall ranking of the performance;
generate a report listing the assessment data and render the report on a user interface of the computer system, wherein a layout of the user interface is configured to display at least some of the assessment data simultaneously with at least some of the performance data, the displayed at least some of the assessment data including the overall ranking; and
based on the assessment data, modify the set of one or more trackable criteria.

18. The one or more hardware storage device(s) of claim 17, wherein execution of the computer-executable instructions further causes the computer system to:
determine a skill level of the instructee;
determine current equipment the instructee currently has;
determine a next set of trackable criteria the instructee is to perform; and
based on (i) the skill level, (ii) the current equipment, and (iii) the next set of trackable criteria, generate a recommendation listing a set of recommended equipment for the instructee, the set of recommended equipment being equipment selected to facilitate performance of the next set of trackable criteria.

19. The one or more hardware storage device(s) of claim 17, wherein the user interface displays an aggregate video clip that is an aggregation of a plurality of video clips recording the performance of the set of one or more trackable criteria, and wherein a camera that recorded at least one video clip included in the plurality of video clips was triggered to begin recording the at least one video clip in response to a detected movement of the instructee.

20. The one or more hardware storage device(s) of claim 17, wherein the user interface simultaneously displays a plurality of video clips that each record at least a portion of the performance of the set of one or more trackable criteria.
